(19) United States
(12) Patent Application Publication
(10) Pub. No.: US 2026/0290676 A1
(43) Pub. Date: Sep. 24, 2026

(54) COIL COMPONENT, METHOD FOR MANUFACTURING COIL COMPONENT, AND ELECTRONIC/ELECTRIC DEVICE

(71) Applicant: DELTA ELECTRONICS (JAPAN), INC., Tokyo (JP)

(72) Inventors: Akira MIYATAKE, Tokyo (JP); Ikuo Koyama, Tokyo (JP); Miyuki Sato, Tokyo (JP); Kazuhiro Yoshida, Tokyo (JP); Masumi Shiraishi, Tokyo (JP)

(73) Assignee: DELTA ELECTRONICS (JAPAN), INC., Tokyo (JP)

(21) Appl. No.: 19/632,451

(22) Filed: Mar. 30, 2026

Related U.S. Application Data
(63) Continuation of application No. PCT/JP2023/036595, filed on Oct. 6, 2023.

(51) Int. Cl. H01F 27/28; H01F 27/29; H01F 27/32; H01F 41/04; H01F 41/12

(52) U.S. Cl. CPC H01F 27/2804; H01F 27/2871; H01F 27/292; H01F 27/323; H01F 41/042; H01F 41/122; H01F 2027/2809

(57) ABSTRACT

A coil conductor portion of a coil component has a spiral portion having turns aligned in a second direction intersecting a winding-axis first direction, and includes a first conductor portion of first conductive material extending along the turns, and a second conductor portion of second conductive material covering the first conductor portion. When the turn is cross-sectioned along the first and second directions, in the cross section, two of the lines forming contour of the first conductor portion, aligned in the second direction, have a taper region with narrower spacing toward one end tip in the first direction, and a straight region with substantially equal spacing on the opposite side, and two of the lines forming a contour of the turn, aligned in the second direction, have wider or substantially equal spacing toward the one end tip. The cross section has an ideal quadrangular shape, and DCR is lowered.

### CROSS REFERENCE TO RELATED APPLICATION

This application is a continuation application of PCT Application No. PCT/JP2023/036595, filed on Oct. 6, 2023. The content of the application is incorporated herein by reference.

### BACKGROUND OF THE INVENTION

### 1. Field of the Invention

The present invention relates to a coil component, a method for manufacturing the same, and an electronic/electric device on which the coil component is mounted.

### 2. Description of the Related Art

Patent Document 1 discloses a coil pattern formed on at least one surface of a substrate. The coil pattern including a first plating film formed on the substrate and a second plating film formed to cover the first plating film. The coil pattern is respectively formed in a spiral shape on both surfaces of the substrate. At least a part of the first plating film is connected via a conduction via formed in the substrate, and the first plating film is formed such that its width narrows from a lower surface in contact with the substrate toward an upper surface.

### PRIOR ART DOCUMENT

### Patent Document

[Patent Document 1] PCT Patent Publication No. 2019-508905

### SUMMARY OF THE INVENTION

### Problems to be Solved by the Invention

Recently, the demand for miniaturization of coil components has increased, and in a spiral (having a spiral shape) coil pattern arranged inside a coil component, the gap between adjacent turns in a direction intersecting the spiral direction has become particularly small. For this reason, if the shape of the first plating film in Patent Document 1 is merely narrowed from the lower surface in contact with the substrate toward the upper surface, it has become difficult to make the cross section rectangular. Based on such circumstances, an object of the present invention is to provide a coil component capable of making the shape of a coil cross section closer to a rectangle even when the gap between adjacent turns is narrowed. In addition, an object of the present invention is to provide a method for manufacturing the coil component and an electronic/electric device on which the coil component is mounted.

### Means to Solve the Problems

In one aspect, the present invention provides a coil component to solve the above problems. The coil component includes: a coil conductor portion having a portion formed with a spiral shape, where a first direction is used as a winding axis direction, and including a plurality of turns aligned in a second direction intersecting the first direction. The coil conductor portion includes a first conductor portion made of a first conductive material and having a portion extending along an extending direction of the turns, and a second conductor portion made of a second conductive material and provided so as to cover at least a part of the first conductor portion. When the turn is cut along a plane including the first direction and the second direction to obtain a first cross section, among lines forming an outer shape of the first conductor portion in the first cross section, two lines aligned in the second direction have a taper region whose spacing becomes narrower toward a tip on one side in the first direction, and a straight region whose spacing is substantially equal on the other side in the first direction. Further, among lines forming an outer shape of the turn in the first cross section, two lines aligned in the second direction have a spacing that becomes wider toward the tip on the one side in the first direction, or the spacing is substantially equal.

Since the outer shape of the first conductor portion has the straight region and the taper region in the cross section of the turn, the shape stability of the first conductor portion is improved, and as a result, it is more stably realized that the cross section of the turn becomes an ideal quadrangular shape.

In another aspect, the present invention is a coil component including: a coil conductor portion including a portion having a spiral shape having a plurality of turns aligned in a second direction intersecting a first direction, with the first direction as a winding axis direction, wherein the coil conductor portion has a first conductor portion made of a first conductive material and having a portion extending along an extending direction of the turns, and a second conductor portion made of a second conductive material and provided so as to cover at least a part of the first conductor portion, wherein when the turn is cut along a plane including the first direction and the second direction to obtain a first cross section, among lines forming an outer shape of the first conductor portion in the first cross section, two lines aligned in the second direction are divided into two equal parts in the first direction to define a first region R1 and a second region R2 from one end side, and among lines forming an outer shape of the turn in the first cross section, two lines aligned in the second direction are divided into two equal parts in the first direction to define a third region R3 and a fourth region R4 from the one end side. Regarding an average inclination angle of each region with respect to the first direction, when an inclination in a direction in which the two lines approach each other is defined as positive, the average inclination angle θ1 of the first region is larger than both the average inclination angle θ2 of the second region and the average inclination angle θ3 of the third region.

When the average inclination angles θ1 to θ3 satisfy the above relationship in the cross section of the turn, the shape stability of the first conductor portion is improved, and as a result, it is more stably realized that the cross section of the turn becomes an ideal quadrangular shape.

In the above coil component, regarding two surfaces facing the first direction in the first conductor portion, when the one having a longer length in the second direction is defined as a first bottom surface and the other is defined as a first top surface, a width W1b that is a length of the first bottom surface in the second direction, a width W1t that is a length of the first top surface in the second direction, a width W2b that is a length of the turn in the second direction at a position of the first bottom surface, and a width W2t that is a length in the second direction of a surface proximal to the first top surface among two surfaces facing the first direction in the turn may satisfy the following formula (1) and the following formula (2).

$$W 1 b > W 1 t \qquad ( 1 )$$

$$( W 1 t / W 1 b ) / ( W 2 t / W 2 b ) < 0.93 \qquad ( 2 )$$

In the above coil component, when the first conductive material includes a crystalline metallic material and a crystal growth direction of the crystalline metallic material is along the first direction, the shape control of the cross section of the turn based on the shape control of the first conductive material as described above can be easily achieved.

In the above coil component, the coil conductor portion may have a first spiral conductor portion and a second spiral conductor portion aligned in the first direction as the portion having the spiral shape, and may have a via portion electrically connecting an inner-side end part of the first spiral conductor portion and an inner-side end part of the second spiral conductor portion.

The above coil component may further include: a main body portion covering at least a part of the coil conductor portion from both sides in the first direction and containing magnetic powder; and a pair of external electrodes in contact with a surface of the coil conductor portion exposed from the main body portion and electrically connected through the coil conductor portion, and in this case, a surface of at least a part of a portion located inside the main body portion in the coil conductor portion may be covered with a coil insulator portion.

In another aspect, the present invention provides an electronic/electric device on which the above coil component is mounted, wherein the coil component is connected to a substrate via the pair of external electrodes. Examples of such an electronic/electric device include a power supply device provided with a power switching circuit, a voltage step-up/step-down circuit, a smoothing circuit, etc., and a compact portable communication device. Since the electronic/electric device according to the present invention includes the above coil component, it has excellent overall characteristics as an inductance element.

In yet another aspect, the present invention provides a method for manufacturing a coil component to manufacture a coil conductor portion having a spiral shape with a first direction as a winding axis direction, the method comprising: forming an insulating negative pattern on a conductive layer of a substrate having the conductive layer on a main surface whose normal is the first direction; forming a first conductor portion by an electroplating process in which an electric current is applied to the conductive layer; removing the negative pattern; removing the conductive layer exposed by removal of the negative pattern; and forming a second conductor portion so as to cover an exposed portion of the first conductor portion. In such a manufacturing method, the negative pattern has a stripe portion in which a plurality of lines are aligned in a second direction that is one of in-plane directions of the main surface, and formation of the stripe portion includes performing exposure such that a portion distal from the substrate in a sheet-shaped negative resist provided on the main surface is positioned in front of a depth of focus.

In the above method for manufacturing the coil component, a length of the depth of focus may be 35% or more of a thickness of the first conductor portion.

In the above method for manufacturing the coil component, a development surface formed by development in the line of the stripe portion may have a negative taper region inclined with respect to the first direction, and a negative straight region along the first direction.

### Effect of the Invention

According to the present invention, there is provided a coil component capable of making the shape of a coil cross section closer to a quadrangular shape even when the gap between adjacent turns is narrowed. In addition, according to the present invention, it is easy to lower a direct current resistance (DCR) of the coil component, and a coil component having excellent electrical characteristics is provided. An electronic/electric device on which this coil component is mounted can improve its performance or reduce its dimensions. Furthermore, the above method for manufacturing the coil component is also provided.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view conceptually illustrating the shape of a coil component according to an embodiment of the present invention.

FIG. 2 is a diagram illustrating the structure of a coil conductor portion provided in the coil component according to an embodiment of the present invention.

FIG. 3 is an XY plan view illustrating the structure of a first spiral conductor portion provided in the coil component according to an embodiment of the present invention.

FIG. 4 is an XZ cross-sectional view taken along line A-A′ in FIG. 2.

FIG. 5A is an XZ cross-sectional view illustrating the structure of a first spiral conductor portion provided in the coil component according to an embodiment of the present invention.

FIG. 5B is an XZ cross-sectional view illustrating the structure of a first spiral conductor portion provided in a coil component according to a conventional technique.

FIG. 5C is an XZ cross-sectional view illustrating the structure of a modification (Modification 1) of the first spiral conductor portion provided in the coil component according to an embodiment of the present invention.

FIG. 5D is an XZ cross-sectional view illustrating the structure of a modification (Modification 2) of the first spiral conductor portion provided in the coil component according to an embodiment of the present invention.

FIG. 5E is an XZ cross-sectional view illustrating the structure of a modification (Modification 3) of the first spiral conductor portion provided in the coil component according to an embodiment of the present invention.

FIG. 6A is an XZ cross-sectional view illustrating the structure of a turn of the first spiral conductor portion provided in the coil component according to an embodiment of the present invention.

FIG. 6B is an XZ cross-sectional view illustrating the structure of a turn of a modification (Modification 4) of the first spiral conductor portion provided in the coil component according to an embodiment of the present invention.

FIG. 7A is an XZ cross-sectional view illustrating the structure of a turn of the first spiral conductor portion provided in the coil component according to an embodiment of the present invention.

FIG. 7B is an XZ cross-sectional view illustrating the structure of a turn of a modification (Modification 4) of the first spiral conductor portion provided in the coil component according to an embodiment of the present invention.

FIG. 8 is a partially enlarged view of FIG. 4.

FIG. 9 is a partially enlarged view of FIG. 8.

FIG. 10 is an explanatory diagram (Part 1) illustrating an example of a method for manufacturing the coil component according to an embodiment of the present invention.

FIG. 11 is an explanatory diagram (Part 2) illustrating an example of a method for manufacturing the coil component according to an embodiment of the present invention.

FIG. 12 is an explanatory diagram (Part 3) illustrating an example of a method for manufacturing the coil component according to an embodiment of the present invention.

FIG. 13 is an explanatory diagram (Part 4) illustrating an example of a method for manufacturing the coil component according to an embodiment of the present invention.

FIG. 14 is an explanatory diagram (Part 5) illustrating an example of a method for manufacturing the coil component according to an embodiment of the present invention.

FIG. 15 is a detailed diagram illustrating an example of the method for manufacturing the coil component (exposure process) according to an embodiment of the present invention.

FIG. 16 is a detailed diagram illustrating an example of the method for manufacturing the coil component (after development process) according to an embodiment of the present invention.

FIG. 17 is a detailed diagram illustrating an example of the method for manufacturing the coil component (after first plating process) according to an embodiment of the present invention.

FIG. 18 is a detailed diagram illustrating an example of a method for manufacturing a coil component (exposure process) according to a conventional technique (No. 1).

FIG. 19 is a detailed diagram illustrating an exemplified method for manufacturing the coil component (after development process) according to the conventional technique (No. 1).

FIG. 20 is a detailed diagram illustrating an exemplified method for manufacturing the coil component (after first plating process) according to the conventional technique (No. 1).

FIG. 21 is a detailed diagram illustrating an exemplified method for manufacturing a coil component (exposure process) according to a conventional technique (No. 2).

FIG. 22 is a detailed diagram illustrating an exemplified method for manufacturing the coil component (after development process) according to the conventional technique (No. 2).

FIG. 23 is a detailed diagram illustrating an exemplified method for manufacturing the coil component (after development process, when defect occurs) according to the conventional technique (No. 2).

FIG. 24 is a detailed diagram illustrating an exemplified method for manufacturing the coil component (after first plating process when a defect occurs) according to the conventional technique (No. 2).

### DETAILED DESCRIPTION

Below, embodiments of the present invention will be described in detail with reference to the drawings.

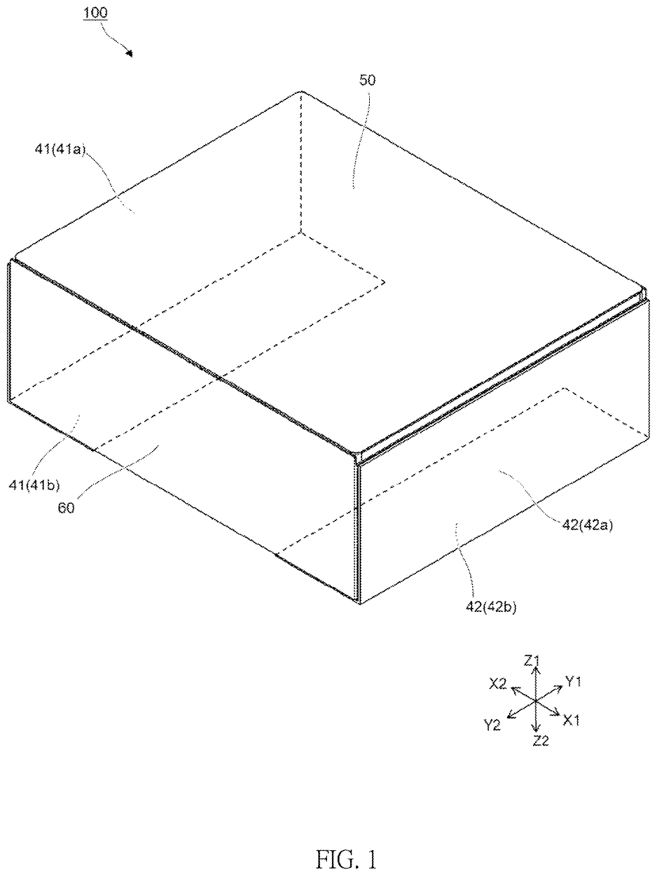

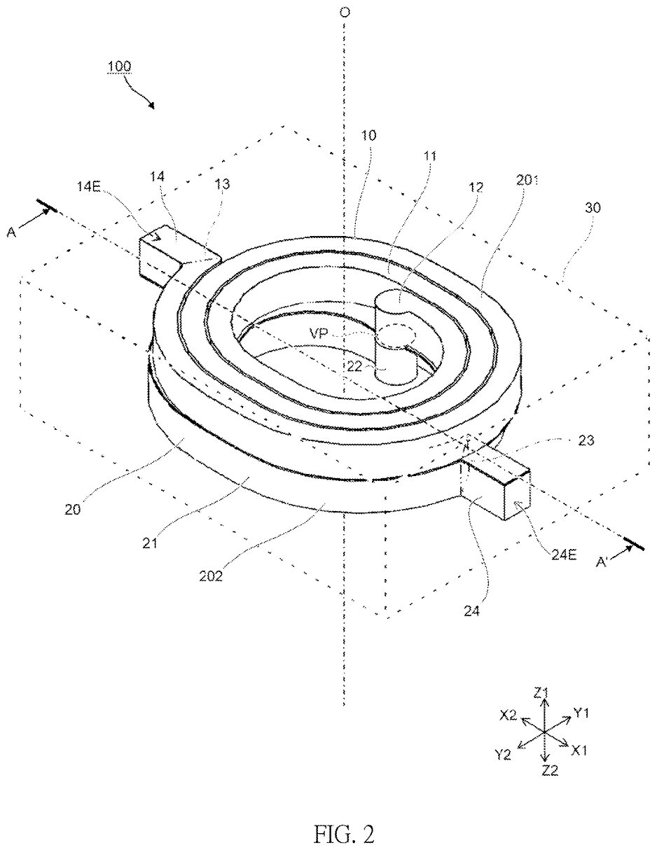

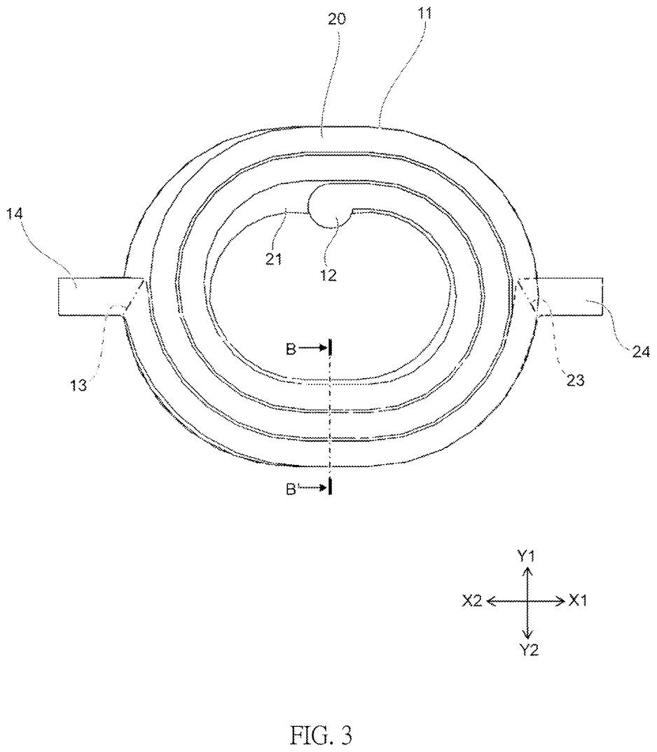

FIG. 1 is a perspective view conceptually illustrating the shape of a coil component according to an embodiment of the present invention. FIG. 2 is a diagram illustrating the structure of a coil conductor portion provided in the coil component according to an embodiment of the present invention. In FIG. 2, for convenience of explanation, the coil conductor portion is drawn with solid lines, the main body portion is drawn with broken lines, and other components are omitted. FIG. 3 is an XY plan view illustrating the structure of a first spiral conductor portion provided in the coil component according to an embodiment of the present invention (a view of the coil conductor portion as viewed from Z1 side in Z1-Z2 direction).

### (Overall Configuration)

A coil component 100 according to an embodiment of the present invention includes a coil portion 10 having a coil conductor portion 20, a main body portion 30, a first external electrode 41, a second external electrode 42, and outer covers 50 and 60.

### (Coil)

As shown in FIG. 2 and FIG. 3, the coil portion 10 includes a coil conductor portion 20 including a first coil conductor portion 201 having a first spiral conductor portion 11. The first spiral conductor portion 11 has a spiral shape around an axis O along a first direction (Z1-Z2 direction), extending from an inner-side end part 12 of the first spiral conductor portion 11 to an outer-side end part 13 of the first spiral conductor portion 11, while moving away from the axis O. That is, the first spiral conductor portion 11 has the first direction as a winding axis direction. In FIG. 2, when viewed from the Z1 side in the Z1-Z2 direction, the first spiral conductor portion 11 is arranged in a clockwise spiral from the inner-side end part 12 toward the outer-side end part 13, moving away from the axis O. In the present specification, the “spiral direction” in the spiral portion means a direction from the inner-side end part 12 toward the outer-side end part 13. The same definition applies to a second spiral conductor portion 21.

The conductor (conductive material) constituting the coil conductor portion 20 is not limited as long as it has appropriate conductivity. Metals such as copper, copper alloys, aluminum, and aluminum alloys can be cited as specific examples of the conductor constituting the coil conductor portion 20, and the coil conductor portion 20 can be manufactured using a film formation technique such as plating, for example. The coil portion 10 has an insulating coil insulator portion (not shown in FIG. 1 to FIG. 3) on the surface of the coil conductor portion 20. By this coil insulator portion, insulation is ensured between adjacent conductors (between surfaces of conductors facing each other) in the coil conductor portion 20. The coil insulator portion is formed of, for example, a resin material. No coil insulator portion is provided at the ends of the two end portions (first lead-out portion 14 and the second lead-out portion 24) of the coil conductor portion 20, and the coil portion 10 can be electrically connected to other members (first external electrode 41 and the second external electrode 42) at these ends.

As shown in FIG. 2, the coil conductor portion 20 includes a second coil conductor portion 202 having a second spiral conductor portion 21 arranged alongside the first spiral conductor portion 11 in the first direction (Z1-Z2 direction). The second spiral conductor portion 21 has a spiral shape around the axis O extending along the first direction (Z1-Z2 direction), from an inner-side end part 22, which is an end portion on the inner peripheral side in the second spiral conductor portion 21, toward an outer-side end part 23, which is an end portion on the outer peripheral side in the second spiral conductor portion 21, while moving away from the axis O. That is, the second spiral conductor portion 21 has the first direction as a winding axis direction. In the second spiral conductor portion 21, the conductor is arranged in a spiral shape moving away from the axis O in the direction opposite to the first spiral conductor portion 11 (counterclockwise in FIG. 2) when viewed from the Z1 side in the Z1-Z2 direction.

The average value of the clearance in the first direction (Z1-Z2 direction) between the first spiral conductor portion 11 and the second spiral conductor portion 21 is not particularly limited. The smaller this clearance is, the easier it is to lower the height (dimension in Z1-Z2 direction) of the coil component 100, but if it is excessively small, the insulation between the first spiral conductor portion 11 and the second spiral conductor portion 21 tends to deteriorate. From the viewpoint of achieving both a low profile (low height) of the coil component 100 and high insulation between the first spiral conductor portion 11 and the second spiral conductor portion 21, it may be preferable that the clearance is 0.4 μm or more and 20 μm or less. In terms of manufacturing, in order to reduce variations in the clearance and to more reliably support the coil in the same plane, this clearance is more preferably 1.0 μm or more, and further preferably 5.0 μm or more.

The inner-side end part 12 of the first spiral conductor portion 11 and the inner-side end part 22 of the second spiral conductor portion 21 are electrically connected by a via portion VP. Starting from the connection part to the via portion VP, the first spiral conductor portion 11 and the second spiral conductor portion 21 spiral in opposite directions. The via portion VP may be formed of the same conductor as the coil conductor portion 20. In a specific example, the via portion VP is manufactured simultaneously in the process of manufacturing the first spiral conductor portion 11 and the second spiral conductor portion 21. In this case, the via portion VP is integrated with the inner-side end part 12 of the first spiral conductor portion 11 and the inner-side end part 22 of the second spiral conductor portion 21.

A first lead-out portion 14 is continuously provided at the outer-side end part 13 of the first spiral conductor portion 11 as a part of the first coil conductor portion 201, and a second lead-out portion 24 is continuously provided at the outer-side end part 23 of the second spiral conductor portion 21 as a part of the second coil conductor portion 202. Therefore, the outer-side end part 13 of the first spiral conductor portion 11 is substantially an interface with the first lead-out portion 14, and the outer-side end part 23 of the second spiral conductor portion 21 is substantially an interface with the second lead-out portion 24. In a specific example, the first lead-out portion 14 and the second lead-out portion 24 are manufactured simultaneously in the process of manufacturing the first spiral conductor portion 11 and the second spiral conductor portion 21. In this case, the first lead-out portion 14 has a portion integrated without a boundary with the outer-side end part 13 of the first spiral conductor portion 11, and the second lead-out portion 24 has a portion integrated without a boundary with the outer-side end part 23 of the second spiral conductor portion 21.

That is, in this embodiment, the coil conductor portion 20 has the first coil conductor portion 201 having the first spiral conductor portion 11 and the first lead-out portion 14, the second coil conductor portion 202 having the second spiral conductor portion 21 and the second lead-out portion 24, and the via portion VP, which are manufactured in a common manufacturing process to have integrally formed portions (specifically, portions made of a first conductive material).

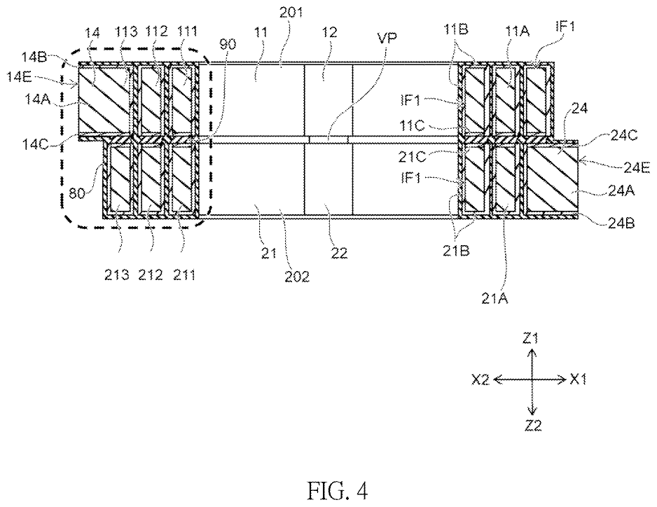

FIG. 4 is an XZ cross-sectional view taken along line A-A′ in FIG. 2. In FIG. 2, the line A-A′ passes through the center in the Z1-Z2 direction and the Y1-Y2 direction of the first coil conductor portion 201 and is a line along the X1-X2 direction, and FIG. 4 is a cross-sectional view in the XZ plane including this line. As shown in FIG. 4, each turn of the first spiral conductor portion 11 and each turn of the second spiral conductor portion 21 are positioned so as to be arranged in the first direction (Z1-Z2 direction). The first spiral conductor portion 11 includes a first inner-side turn 111 which is a turn located at the innermost periphery, a first outer-side turn 113 which is a turn located at the outermost periphery, and a first central turn 112 which is a turn located between these, and the second spiral conductor portion 21 includes a second inner-side turn 211 which is a turn located at the innermost periphery, a second outer-side turn 213 which is a turn located at the outermost periphery, and a second central turn 212 which is a turn located between these.

The second inner-side turn 211 is located on the Z2 side in the Z1-Z2 direction of the first inner-side turn 111, the second outer-side turn 213 is located on the Z2 side in the Z1-Z2 direction of the first outer-side turn 113, and the second central turn 212 is located on the Z2 side in the Z1-Z2 direction of the first central turn 112. In the coil portion 10 shown in FIG. 2, the second lead-out portion 24 does not exist on the Z2 side in the Z1-Z2 direction of the outer-side end part 13 of the first spiral conductor portion 11, and the first lead-out portion 14 does not exist on the Z1 side in the Z1-Z2 direction of the outer-side end part 23 of the second spiral conductor portion 21.

### (First Conductor Portion, Second Conductor Portion)

As shown in FIG. 4, the first spiral conductor portion 11 has a first conductor portion 11A extending along the extending direction of the turn, that is, from the inner-side end part 12 to the outer-side end part 13 of the first spiral conductor portion 11 along the spiral direction and made of a first conductive material, and a second conductor portion 11B electrically connected to the first conductor portion 11A at a first interface IF1 along the first direction (Z1-Z2 direction) and made of a second conductive material. As will be described later, in one example, the first conductor portion 11A and the second conductor portion 11B are manufactured by different manufacturing processes. In this case, even if they are the same type of material (e.g., Cu, Cu alloy, etc., materials containing Cu), they can be distinguished by cross-sectional observation because microstructural characteristics such as crystal structure, crystal orientation, and crystal growth direction are different. In a specific example, the first conductor portion 11A is formed of an electroplated deposit (electrolytic plated deposit), and the second conductor portion 11B is formed of a plated deposit. In this case, the plated deposit may be an electroplated deposit or an electroless plated deposit. From the viewpoint of reducing the thickness of the second conductor portion 11B, it is preferable that the plated deposit is an electroplated deposit.

At an end portion of the first conductor portion 11A on the side facing the second spiral conductor portion 21 (Z2 side in Z1-Z2 direction) in the first direction (Z1-Z2 direction), a third conductor portion 11C as shown in FIG. 4 may be provided. The material constituting the third conductor portion 11C is not limited. It may be the same type as the material constituting the first conductor portion 11A (for example, a material containing Cu such as Cu or a Cu alloy), or may be different. From a manufacturing viewpoint (base film for electroplating), it may be preferable that the third conductor portion 11C is made of a material containing at least one of Ni and Cr. It may be preferable that the material constituting the first conductor portion 11A and the material constituting the third conductor portion 11C have different etching characteristics. For example, when the first conductor portion 11A is made of Cu and the third conductor portion 11C is made of Ni, it is possible to etch Ni with high selectivity depending on the etching conditions. The third conductor portion 11C may be in the form of a film, or may be composed of a laminated film of different materials.

As shown in FIG. 4, also in the second spiral conductor portion 21, similarly to the first spiral conductor portion 11, a second conductor portion 21B is provided so as to cover a laminated body of a first conductor portion 21A and a third conductor portion 21C. The first conductor portion 21A is made of the same material as the first conductor portion 11A, the second conductor portion 21B is made of the same material as the second conductor portion 11B, and the third conductor portion 21C is made of the same material as the third conductor portion 11C. Therefore, the first conductor portions 11A and 21A have portions extending along the extending direction of the turns of the coil conductor portion 20. Coil insulator portions (first insulator portion 90, second insulator portion 80) will be described later.

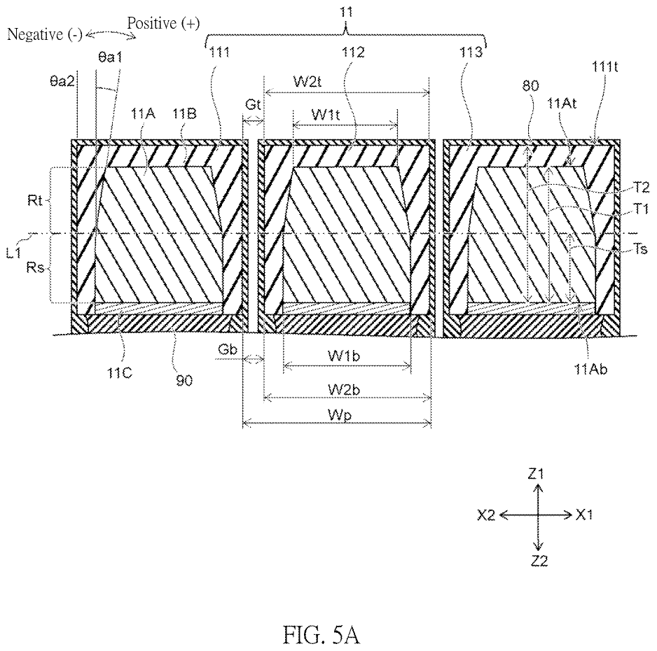

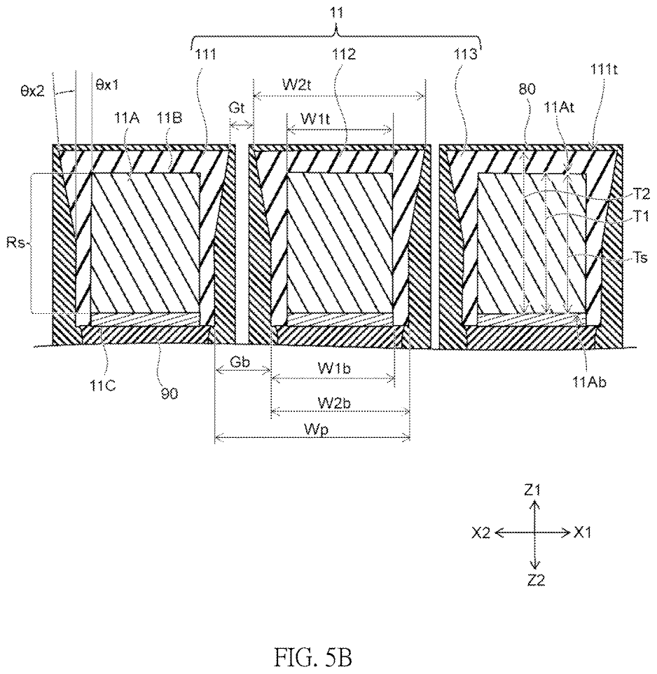

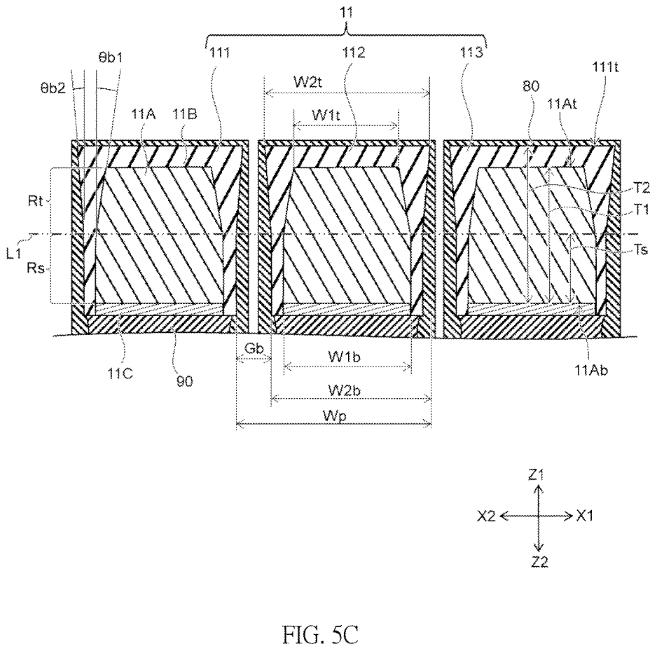

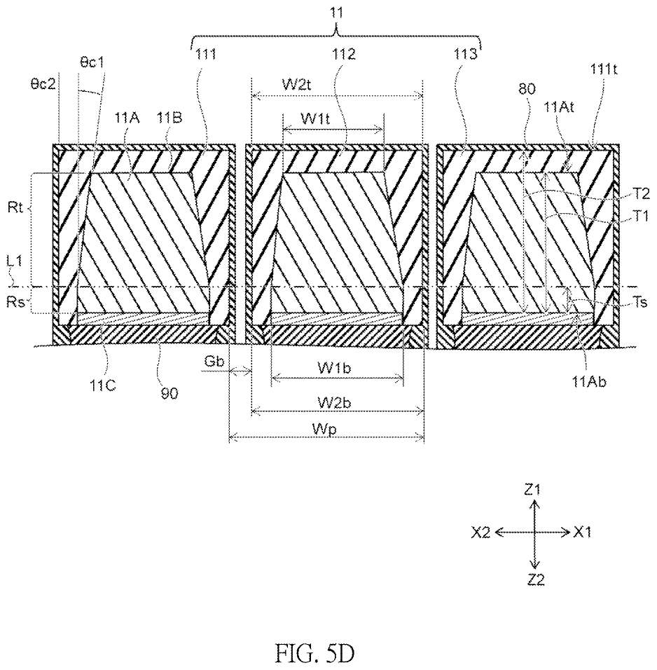

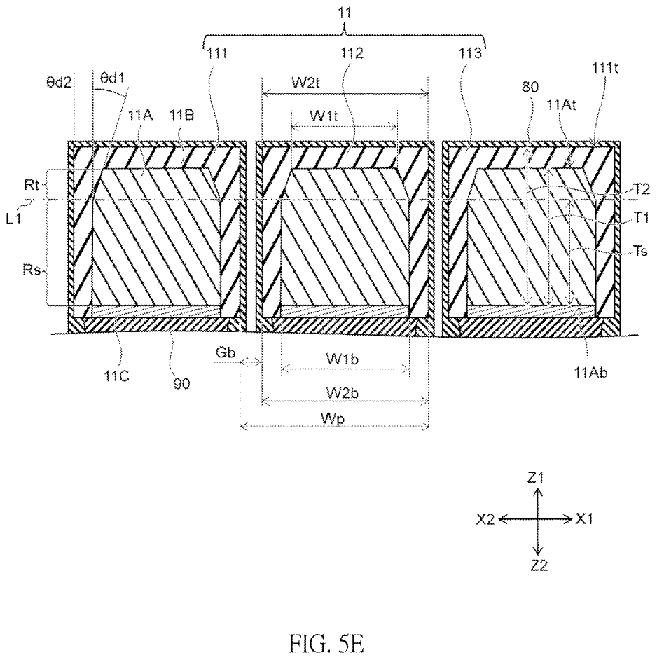

FIG. 5A is an XZ cross-sectional view illustrating the structure of the first spiral conductor portion provided in the coil component according to an embodiment of the present invention, and specifically, a part of the XZ cross-sectional view taken along line B-B′ in FIG. 3 is displayed. FIG. 5B is an XZ cross-sectional view illustrating the structure of a first spiral conductor portion provided in a coil component according to a conventional technique. For easy comparison, FIG. 5B also shows the structure of the first spiral conductor portion according to this embodiment shown in FIG. 5A.

Although shown in FIG. 4 briefly, the turns of the coil conductor portion of the coil component 100 according to the present embodiment have a detailed structure as shown in FIG. 5A. FIG. 5A shows three turns of the first spiral conductor portion 11, specifically, the first inner-side turn 111, the first central turn 112, and the first outer-side turn 113 in the XZ cross-sectional view taken along the line B-B′ of FIG. 3, together with insulator portions (second insulator portion 80, first insulator portion 90) in contact with these turns.

Taking the first inner-side turn 111 as a specific example, when the first inner-side turn 111 is cut along a plane (XZ plane) including a first direction (Z1-Z2 direction) and a second direction (X1-X2 direction in FIG. 5A), which is a direction intersecting the first direction, a first cross section is obtained. Among lines forming an outer shape of the first conductor portion 11A in the first cross section, two lines aligned in the second direction (X1-X2 direction) have a taper region Rt whose spacing narrows toward a tip on one side in the first direction, specifically on the Z1 side in the Z1-Z2 direction where the first insulator portion 90 is not provided, and a straight region Rs whose spacing is substantially equal on the other side in the first direction, specifically on the Z2 side in the Z1-Z2 direction where the first insulator portion 90 is provided. In the example shown in FIG. 5A, with a virtual line L1 along the X1-X2 direction in between, the Z1 side in the Z1-Z2 direction is the taper region Rt, and the Z2 side in the Z1-Z2 direction is the straight region Rs. FIG. 5A shows the thickness of the straight region (straight region thickness Ts), the thickness of the first conductor portion 11A (first conductor portion thickness T1), and the thickness of the turn (turn thickness T2). The same definition applies to the subsequent figures (FIG. 5B to FIG. 5E). The first cross section is typically a plane including the axis O and orthogonal to the XY plane, and in the specific example shown in FIG. 5A, the first cross section consists of an XZ cross section taken along line B-B′ in FIG. 3. Further, as a specific example, the virtual line L1 is set as a boundary between the straight region Rs and the taper region Rt, but this boundary does not have to be clear. That is, the taper region Rt may be reached by gradually increasing the degree of taper from the straight region Rs.

FIG. 5A shows an average inclination angle θa1 of the taper region Rt with respect to the first direction (Z1-Z2 direction). In this specification, the average inclination angle refers to an angle of a reference line with respect to the Z1-Z2 direction that minimizes the total area of regions enclosed by the target line segment and the reference line, when a reference line inclined at a predetermined angle from the Z1-Z2 direction is drawn starting from one end point (for example, the end point on Z2 side in Z1-Z2 direction) of the target line segment toward the other end point side (Z1 side in Z1-Z2 direction), and assuming that a region on the inner side of the first conductor portion 11A from the reference line is taken as positive and a region on the outer side of the first conductor portion 11A from the reference line is taken as negative (where, with respect to the end portion on Z1 side in Z1-Z2 direction of the line segment, the region is defined also using a point at which a line drawn in X1-X2 direction from the end point on the Z1 side in Z1-Z2 direction intersects the reference line). Here, the average inclination angle is defined to be positive when inclined toward the inner side of the first conductor portion 11A, and to be negative when inclined toward the outer side.

Since the turn of the coil conductor portion of the coil component 100 according to this embodiment has the straight region Rs in addition to the taper region Rt, the shape stability of the first conductor portions 11A, 21A is improved, and as a result, an ideal quadrangular cross-sectional shape of the turn can be more stably achieved.

Among the lines forming the outer shape of the turn (first inner-side turn 111) in the first cross section, the spacing between two lines aligned in the second direction (X1-X2 direction) on one side in the first direction is substantially equal from the viewpoint of being close to the ideal cross-sectional shape of the turn. In FIG. 5A, while the average inclination angle θa1 of the taper region Rt is a positive value, the average inclination angle θa2 of two lines aligned in the second direction (X1-X2 direction) among the lines forming the outer shape of the first inner-side turn 111 in the first cross section is close to 0 degrees. In this way, since the lines forming the outer shape of the first inner-side turn 111 in the first cross section approach an ideal quadrangular shape, a gap Gt on one side in the first direction (Z1 side in Z1-Z2 direction) and a gap Gb on the other side in the first direction (Z2 side in Z1-Z2 direction) between adjacent turns are substantially equal, allowing both to be set to small values.

In a turn according to a conventional technique where the first conductor portion 11A does not have the taper region Rt as shown in FIG. 5B, an average inclination angle θx1 corresponding to the average inclination angle θa1 of the coil component 100 according to the present embodiment is approximately 0 degrees. In this case, among the lines forming the outer shape of the first inner-side turn 111 in the first cross section, the average inclination angle θx2 of two lines aligned in the second direction (X1-X2 direction) tends to be a negative value, depending on the formation method of the second conductor portion 11B, and the two lines tend to become increasingly separated from each other so as to form a taper (reverse taper). When the formation method of the second conductor portion 11B is a plating process performed with a substrate arranged to face the third conductor portion 11C in the Z1-Z2 direction, the plating deposition rate increases as the distance from the substrate increases due to the difference in plating solution circulation efficiency between the side where the substrate is located (Z2 side) and the opposite side (Z1 side). Therefore, the above-mentioned reverse taper is particularly easy to form.

When the reverse taper is formed, the gap Gt on one side in the first direction (Z1 side) between adjacent turns becomes smaller than the gap Gb on the other side in the first direction (Z2 side), and the cross-sectional shape of the turn deviates from the ideal quadrangular shape. Therefore, the cross-sectional area of the turn is reduced, and the DC resistance (DCR) is increased. Comparing FIG. 5A and FIG. 5B, the length (width W2b) on the other side (Z2 side) in the first direction of the turn of the coil component 100 according to this embodiment is larger than the length (width W2b) on the other side (Z2 side) in the first direction of the conventional turn.

In the coil component 100 according to the present embodiment, when the first conductive material (the constituent material of first conductor portion 11A) includes a crystalline metallic material and its crystal growth direction is along the first direction, the shape control of the cross section of the turn based on the shape control of the first conductor portion 11A is easily achieved. If the first conductor portion 11A is formed to grow in the first direction using a film formation technique such as plating or sputtering, it easily exhibits such crystallographic features.

FIGS. 5C to 5E are XZ cross-sectional views illustrating structures of Modifications 1 to 3 of the first spiral conductor portion provided in the coil component according to an embodiment of the present invention. In Modification 1 shown in FIG. 5C, among the lines forming the outer shape of the turn (first inner-side turn 111) in the first cross section, two lines aligned in the second direction (X1-X2 direction) have a wider spacing as they approach the distal end on one side in the first direction (Z1 side). Therefore, although the average inclination angle θb1 of the taper region Rt of the first conductor portion 11A in this example has a positive value similarly to the average inclination angle θa1 of the structure shown in FIG. 5A, the average inclination angle θb2 for a region where the width in the second direction of the outer shape of the turn becomes larger has a negative value. The cross section of the turn in this example is farther from the ideal quadrangular shape than the cross section of the turn shown in FIG. 5A, but is closer to the ideal quadrangular shape than the cross section of the turn shown in FIG. 5B. Since the gap between adjacent turns is also narrow, the DC resistance (DCR) of the coil component 100 tends to be low.

In the turn of Modification 2 shown in FIG. 5D, in comparison with the turn shown in FIG. 5A, the position of the virtual line L1 serving as a boundary between the taper region Rt and the straight region Rs is shifted toward the other side in the first direction (Z2 side), and thus the straight region thickness Ts is relatively thin. On the other hand, other shape characteristics of the first conductor portion 11A (specifically, the first conductor portion thickness T1, the width W1t in the X1-X2 direction of the surface on the Z1 side, and the width W1b in the X1-X2 direction of the surface on the Z2 side) are almost equal. Therefore, although the average inclination angle θc1 of the taper region Rt of the first conductor portion 11A in this example is a positive value, it is smaller than the average inclination angle θa1 of the taper region Rt shown in FIG. 5A.

On the other hand, in the turn of Modification 3 shown in FIG. 5E, in comparison with the turn shown in FIG. 5A, the position of the virtual line L1 serving as the boundary between the taper region Rt and the straight region Rs is shifted toward one side in the first direction (Z1 side), and thus the straight region thickness Ts is relatively thick. On the other hand, other shape characteristics of the first conductor portion 11A are almost equal. Therefore, the average inclination angle θd1 of the taper region Rt of the first conductor portion 11A in this example is a positive value, and is larger than the average inclination angle θa1 of the taper region Rt shown in FIG. 5A.

In both Modification 2 shown in FIG. 5D and Modification 3 shown in FIG. 5E, by adjusting the formation conditions of the second conductor portion 11B, similarly to the turn shown in FIG. 5A, the average inclination angles θc2 and θd2 of two lines aligned in the second direction (X1-X2 direction) among the lines forming the outer shape of the first inner-side turn 111 in the first cross section are approximately 0 degrees.

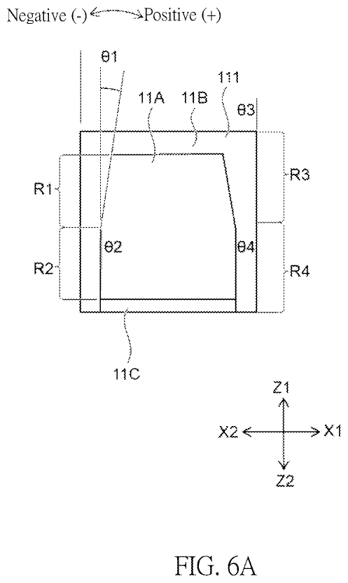

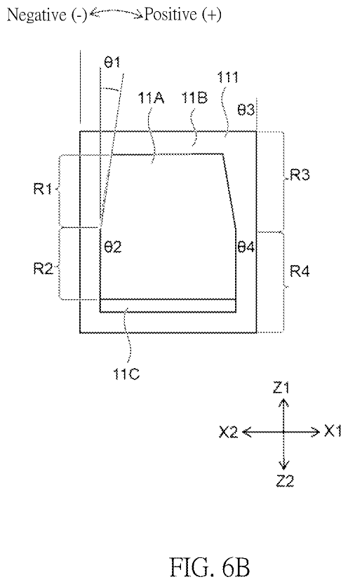

FIG. 6A is an XZ cross-sectional view illustrating the structure of a turn of the first spiral conductor portion provided in the coil component according to an embodiment of the present invention. As shown in FIG. 6A, when the turn (first inner-side turn 111) is cut along a plane including the first direction (Z1-Z2 direction) and the second direction (X1-X2 direction) to obtain a first cross section, among lines forming the outer shape of the first conductor portion 11A in the first cross section, two lines aligned in the second direction (X1-X2 direction) are divided into two equal parts in the first direction (Z1-Z2 direction), and starting from one end side (Z1 side in Z1-Z2 direction), they are defined as a first region R1 and a second region R2. Among lines forming an outer shape of the turn (first inner-side turn 111) in the first cross section, two lines aligned in the second direction (X1-X2 direction) are divided into two equal parts in the first direction (Z1-Z2 direction), and starting from one end side (Z1 side in Z1-Z2 direction), they are defined as a third region R3 and a fourth region R4. Regarding an average inclination angle of each region with respect to the first direction, the inclination manner that the two lines approach each other in a direction is defined as positive. Based on the above definitions, the shape of the turn of the coil component 100 according to the present embodiment can be described from another viewpoint in that the average inclination angle θ1 of the first region R1 is larger than both the average inclination angle θ2 of the second region R2 and the average inclination angle θ3 of the third region R3. In FIG. 6A, the average inclination angles θ2 to θ4 are all approximately 0 degrees. When the average inclination angles θ1 to θ3 satisfy θ1>θ2 and θ1>θ3, the cross section of the turn is likely to have an ideal quadrangular shape, and the coil component 100 according to the present embodiment including the turn having such shape characteristics can easily lower the direct current resistance (DCR).

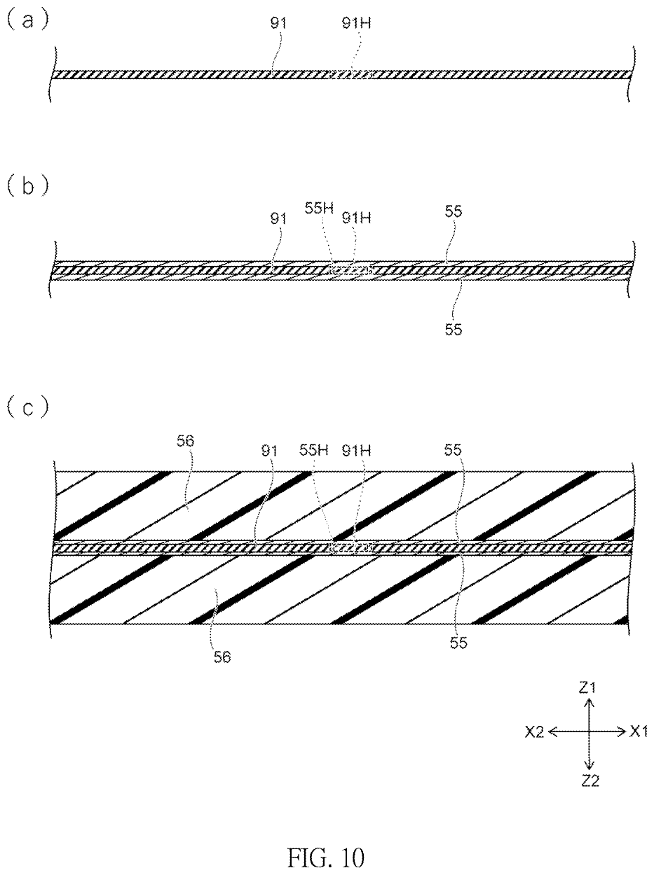

FIG. 6B is an XZ cross-sectional view illustrating the structure of a turn of a modification (Modification 4) of the first spiral conductor portion provided in the coil component according to an embodiment of the present invention. The turn according to this example, in comparison with the turn shown in FIG. 6A, extends around so that the second conductor portion 11B reaches the end portion on the other side in the first direction (Z2 side in Z1-Z2 direction) beyond the third conductor portion 11C. The turn having the structure of the modification (Modification 4) shown in FIG. 6B can be manufactured by modifying a part of the steps in the manufacturing method of the coil component 100 having the turn shown in FIG. 6A. Although details will be described later, while the turn shown in FIG. 6A can be obtained by forming the first conductor portion 11A on a sheet substrate 91 (see FIG. 10) and then forming the second conductor portion 11B leaving the sheet substrate 91 in place, the turn according to this example can be obtained by forming the first conductor portion 11A on the sheet substrate 91, then removing the sheet substrate 91, and then forming the second conductor portion 11B. In the case of this example, the third region R3 and the fourth region R4 are defined including the second conductor portion 11B located at the end portion on the other side in the first direction (Z2 side in Z1-Z2 direction).

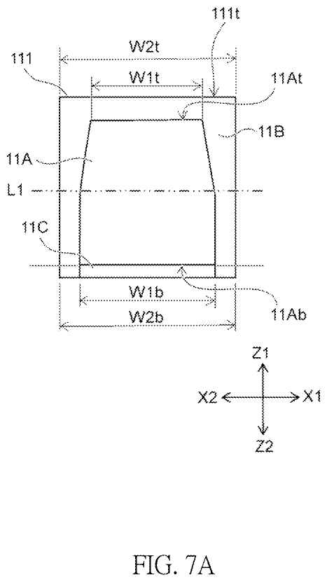

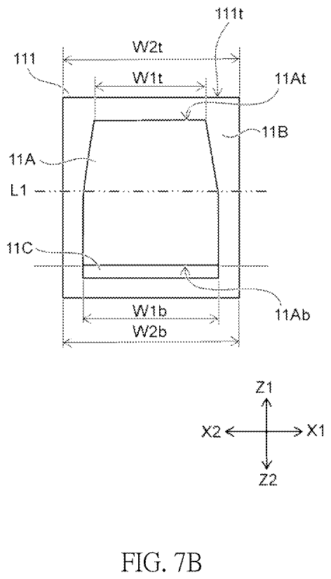

FIG. 7A is an XZ cross-sectional view illustrating the structure of a turn of the first spiral conductor portion provided in the coil component according to an embodiment of the present invention. The structure of the turn shown in FIG. 7A is the same as the structure of the turn shown in FIG. 6A, but the viewpoint for evaluating the shape characteristics is different. In FIG. 6A, the shape characteristics were evaluated by dividing the first conductor portion 11A into two parts in the first direction (Z1-Z2 direction), but in FIG. 7A, focus is placed on lengths in the second direction (X1-X2 direction) of two surfaces facing the first direction (Z1-Z2 direction) in the first conductor portion 11A. Specifically, regarding the two surfaces facing the first direction (Z1-Z2 direction) in the first conductor portion 11A, the one having a longer length in the second direction (X1-X2 direction) (specifically, Z2 side in Z1-Z2 direction) is defined as a first bottom surface 11Ab, and the other (specifically, Z1 side in Z1-Z2 direction) is defined as a first top surface 11At. Further, a length of the first bottom surface 11Ab in the second direction is defined as a width W1b, a length of the first top surface 11At in the second direction is defined as a width W1t, a length of the turn (first inner-side turn 111) in the second direction at a position of the first bottom surface 11Ab is defined as a width W2b, and a length in the second direction of a surface proximal to the first top surface 11At (indicated by 111t in FIG. 7A) among two surfaces facing the first direction in the turn (first inner-side turn 111) is defined as a width W2t. In this case, the turn of the coil component 100 according to the present embodiment satisfies the following formula (1) and the following formula (2).

$$W 1 b > W 1 t \qquad ( 1 )$$

$$( W 1 t / W 1 b ) / ( W 2 t / W 2 b ) < 0.93 \qquad ( 2 )$$

By satisfying the above formula (1) and the above formula (2), it is easily realized that the cross section of the turn has an ideal quadrangular shape. The left side of the above formula (2) is preferably 0.86 or less, more preferably 0.8 or less, further preferably 0.75 or less, and particularly preferably 0.71 or less.

The calculation results of direct current resistance (DCR) for coil components having turns of the structures shown in FIGS. 5A to 5E are shown as follows. For each of the structures, in addition to the above definitions, the height of the first conductor portion 11A in the first direction is defined as T1, the height of the turn in the first direction based on the first bottom surface 11Ab is defined as T2, and the height of the straight region Rs in the first direction is defined as Ts. In addition, an arrangement pitch between adjacent turns is defined as Wp.

The dimensional information of the structures in each figure and the calculation results of the direct current resistance (DCR) are shown in Table 1 below. The “Improvement rate” in Table 1 indicates the reduction rate in the direct current resistance (DCR) based on the direct current resistance (DCR) in the structure of FIG. 5B according to a comparative example. For example, since the DCR in the structure of FIG. 5A according to Example 1 is 26.6 mΩ, and the direct current resistance (DCR) in the structure of FIG. 5B according to the comparative example is 28.0 mΩ, the improvement rate is (28.0−26.6)/28.0×100, which is 5%.

TABLE 1

| | | Comparative | | | | |
|---|---|---|---|---|---|---|
| | | Example | Example 1 | Example 2 | Example 3 | Example 4 |
| | | FIG. 5B | FIG. 5A | FIG. 5C | FIG. 5D | FIG. 5E |
| W1t | μm | 50 | 50 | 50 | 50 | 50 |
| W1b | μm | 50 | 70 | 70 | 70 | 70 |
| W2t | μm | 75 | 75 | 75 | 75 | 75 |
| W2b | μm | 70 | 75 | 72.5 | 75 | 75 |
| T1 | μm | 110 | 110 | 110 | 110 | 110 |
| T2 | μm | 120 | 120 | 120 | 120 | 120 |
| Ts | μm | 110 | 55 | 55 | 27.5 | 82.5 |
| Ts/T1 | % | 1 | 0.5 | 0.5 | 0.25 | 0.75 |
| Gb | μm | 10 | 5 | 7.5 | 5 | 5 |
| Wp | μm | 80 | 80 | 80 | 80 | 80 |
| Cross- | μm² | 8550 | 9000 | 8775 | 9000 | 9000 |
| sectional | | | | | | |
| area | | | | | | |
| DCR | mΩ | 28.0 | 26.6 | 27.3 | 26.6 | 26.6 |

| | | | | | |
|---|---|---|---|---|---|
| Improvement rate | 0% | 5% | 3% | 5% | 5% |
| P1 = W1t/W1b | 1.00 | 0.71 | 0.71 | 0.71 | 0.71 |
| P2 = W2t/W2b | 1.07 | 1.00 | 1.03 | 1.00 | 1.00 |
| P1/P2 | 0.93 | 0.71 | 0.69 | 0.71 | 0.71 |

As shown in Table 1, the structures according to the Examples had a lower direct current resistance (DCR) than the structure according to the Comparative Example, and their improvement rates were 3% to 5%.

FIG. 7B is an XZ cross-sectional view illustrating the structure of a turn of a modification (Modification 4) of the first spiral conductor portion provided in the coil component according to an embodiment of the present invention. The turn according to this example, in comparison with the turn shown in FIG. 7A, is configured such that the second conductor portion 11B extends beyond the third conductor portion 11C toward the end portion on the other side in the first direction (Z2 side in Z1-Z2 direction). In this case as well, the width W2b is defined as the length in the second direction of the turn (first inner-side turn 111) at the position of the first bottom surface 11Ab. When the second conductor portion 11B extends to the end portion on the other side in the first direction (Z2 side in Z1-Z2 direction) beyond the third conductor portion 11C as in this example, the surface at the end portion on the other side in the first direction (Z2 side in Z1-Z2 direction) of the second conductor portion 11B is continuously connected to a surface of the second conductor portion 11B facing the second direction (X1-X2 direction), and as a result, the width of that surface in the second direction (X1-X2 direction) tends to become narrower. In order to appropriately define the shape characteristics of the cross section of the turn even if it has this tendency, the position defining the width W2b is defined at a position away from the end portion on the other side in the first direction (Z2 side in Z1-Z2 direction).

### (First Insulator Portion)

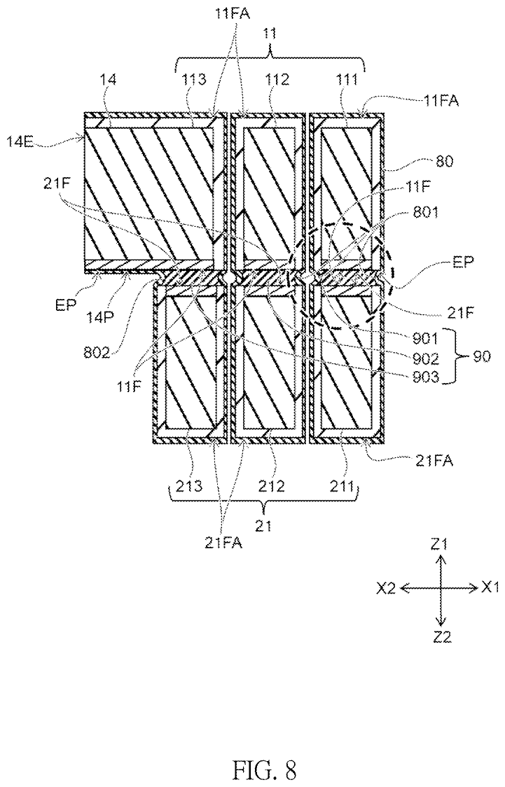

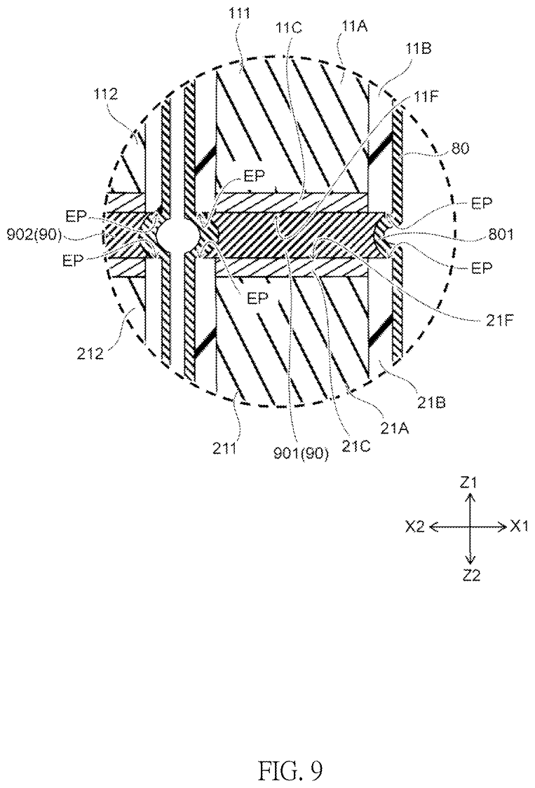

FIG. 8 is a partially enlarged view of FIG. 4, enlarging the area enclosed by a broken line in FIG. 4. FIG. 9 is a partially enlarged view of FIG. 8, enlarging the area indicated by a dashed circle in FIG. 8. As shown in FIG. 9, the coil insulator portion includes a first insulator portion 90 in contact with at least a part of an end portion on one side in the first direction of the first spiral conductor portion 11, specifically an end portion on a side facing the second spiral conductor portion 21 (Z2 side in Z1-Z2 direction). On the side (Z2 side in Z1-Z2 direction) opposite to a side (Z1 side in Z1-Z2 direction) in contact with the first spiral conductor portion 11, the first insulator portion 90 shown in FIG. 9 is in contact with at least a part of an end portion on one side in the first direction of the second spiral conductor portion 21, specifically an end portion on a side facing the first spiral conductor portion 11 (Z1 side in Z1-Z2 direction). That is, the first insulator portion 90 is interposed between the first spiral conductor portion 11 and the second spiral conductor portion 21 arranged in the first direction, and is in contact with both of them.

Since the first insulator portion 90 is in contact with the first spiral conductor portion 11 in this manner, insulation of the first spiral conductor portion 11 is reliably achieved. In addition, as shown in FIG. 9, since the first insulator portion 90 is located between the first spiral conductor portion 11 and the second spiral conductor portion 21 and is in contact with both, a short circuit between the first spiral conductor portion 11 and the second spiral conductor portion 21 is stably avoided.

The material constituting the first insulator portion 90 is not limited as long as it has appropriate insulating properties. It may be preferable that the first insulator portion 90 has a volume resistivity obtained by ASTM D257 of 1.0×10¹⁴ Ωcm or more. This volume resistivity is more preferably 1.0×10¹⁵ Ωcm or more, and further preferably 1.0×10¹⁶ Ωcm or more. The upper limit of the volume resistivity is not particularly limited. The volume resistivity may be 1.0×10²⁰ Ωcm or less. Furthermore, the first insulator portion 90 preferably has excellent dielectric characteristics, and specifically, it may be preferable that the relative permittivity at 60 Hz obtained by ASTM D150 is 4.0 or less. This relative permittivity is more preferably 3.5 or less, and further preferably 3.0 or less. The upper limit of this relative permittivity is not particularly limited. The relative permittivity may be 1.0 or more. Methods for measuring the volume resistivity and relative permittivity of the first insulator portion 90 are not limited as long as results equivalent to the results obtained by the above ASTM D257 and D150 are expected. For example, a measurement sample obtained by preparing a material corresponding to the first insulator portion 90 to dimensions required for measurement may be separately prepared, and the constituent material may be specified through analytical methods such as component analysis and FT-IR using this measurement sample, and characteristics such as volume resistivity may be evaluated for that material.

The material constituting the first insulator portion 90 may be composed of an organic material, an inorganic material, or a composite material of an organic material and an inorganic material. In a case where the first insulator portion 90 is made of a composite material, the inorganic material may have a particle shape and be dispersed in a matrix made of an organic material. Specific examples of organic materials include polyimide resin, polyethylene resin, polypropylene resin, polyamide resin, polyester resin, polyamide-imide resin, polysulfone resin, polycarbonate resin, liquid crystal polymer resin, polyvinylidene fluoride resin, and polytetrafluoroethylene resin. Specific examples of inorganic materials, particularly inorganic materials in composite materials, include inorganic materials such as oxides, carbides, nitrides, and inorganic salts. For example, silica, alumina, and zirconia can be cited as oxides. Also, for example, inorganic materials of silicon carbide and boron nitride can be cited as carbides and nitrides, respectively. Minerals such as wollastonite, kaolin, and mica can be cited as inorganic salts. Among these, oxide-based materials such as oxides, silicates, and phosphates are preferable in terms of cost and insulation. For example, it is preferable that the inorganic material contains at least one selected from the group consisting of silicon (Si), phosphorus (P), boron (B), and calcium (Ca).

In the example shown in FIG. 8, the first insulator portion 90 is present as three independent parts: a first insulator portion 901 located between the first inner-side turn 111 and the second inner-side turn 211, a first insulator portion 902 located between the first central turn 112 and the second central turn 212, and a first insulator portion 903 located between the first outer-side turn 113 and the second outer-side turn 213. In any of the first insulator portions 901, 902, 903, end portions in the X1-X2 direction are located further inward than end portions in the X1-X2 direction of the contacting turns, and the end portions of the turns have portions not in contact with the first insulator portion 90.

Specifically, the end portion on the X1 side in the X1-X2 direction of the first insulator portion 901 is located further inward (X2 side in X1-X2 direction) than the end portion on the X1 side in the X1-X2 direction of the first inner-side turn 111. For this reason, a portion of the first inner-side turn 111 facing the second inner-side turn 211 (first facing portion 11F) has a portion not in contact with the first insulator portion 901 (non-contact portion EP). Based on this non-contact portion EP, as shown in FIG. 9, when viewed in the first direction (Z1-Z2 direction), an envelope of an inner edge of the first insulator portion 90 in contact with the turn constituting an inner edge of the first spiral conductor portion 11, that is, the first inner-side turn 111 located at the innermost periphery, encloses the inner edge of the first spiral conductor portion 11. Similarly, a portion of the second inner-side turn 211 facing the first inner-side turn 111 (second facing portion 21F) has a non-contact portion EP on the X1 side in the X1-X2 direction, and an envelope of an inner edge of the first insulator portion 90 in contact with the second inner-side turn 211 located at the innermost periphery encloses an inner edge of the second spiral conductor portion 21.

Since the first insulator portion 902 is independent from the adjacent first insulator portions 901 and 903 in the XZ cross section, a portion of the first central turn 112 facing the second central turn 212 (first facing portion 11F) has non-contact portions EP at both ends in the X1-X2 direction, and a portion of the second central turn 212 facing the first central turn 112 (second facing portion 21F) has non-contact portions EP at both ends in the X1-X2 direction. Furthermore, since the first insulator portion 903 exists independently from the first insulator portion 902 in the XZ cross section, a portion of the first outer-side turn 113 facing the second outer-side turn 213 (first facing portion 11F) has non-contact portions EP at both ends in the X1-X2 direction, and a portion of the second outer-side turn 213 facing the first outer-side turn 113 (second facing portion 21F) has non-contact portions EP at both ends in the X1-X2 direction. The first insulator portion 90 is also not in contact with an end portion on the X2 side in the X1-X2 direction of the first lead-out portion 14 (first extending portion 14P), which forms a non-contact portion EP.

### (Second Insulator Portion)

The coil insulator portion includes a second insulator portion 80, and as shown in FIG. 4, the second insulator portion 80 is provided on at least a part of a surface of the first coil conductor portion 201 and a surface of the second coil conductor portion 202.

In this embodiment, the second insulator portion 80 is thermoplastic and includes a thermoplastic resin containing a parylene-based polymer. Other examples of thermoplastic resins include polyethylene, polypropylene, polyamide, polyester, polyamide-imide, polyimide, polysulfone, polycarbonate, liquid crystal polymer, polyvinylidene fluoride, polytetrafluoroethylene, and the like. The second insulator portion 80 only needs to be thermoplastic as a whole, and may contain, for example, inorganic insulating particles in addition to the above thermoplastic resin.

The second insulator portion 80 preferably has excellent insulating properties, and specifically, it may be preferable that the volume resistivity obtained by ASTM D257 is 1.0×10¹⁴ Ωcm or more. This volume resistivity is more preferably 1.0×10¹⁵ Ωcm or more, and further preferably 1.0×10¹⁶ Ωcm or more. The upper limit of the volume resistivity is not particularly limited. The volume resistivity may be 1.0×10²⁰ Ωcm or less. Furthermore, the second insulator portion 80 preferably has excellent dielectric characteristics, and specifically, it may be preferable that the relative permittivity at 60 Hz obtained by ASTM D150 is 4.0 or less. This relative permittivity is more preferably 3.5 or less, and further preferably 3.0 or less. The upper limit of this relative permittivity is not particularly limited. The relative permittivity may be 1.0 or more. For the measurement of the volume resistivity and relative permittivity, a separately prepared material corresponding to the second insulator portion 80 adjusted to dimensions necessary for the measurement is used. The material corresponding to the second insulator portion 80 can be identified, for example, through analytical methods such as component analysis and FT-IR, as in the case of the first insulator portion 90.

The second insulator portion 80 has a portion in contact with a portion of the first spiral conductor portion 11 on the side opposite to the side facing the second spiral conductor portion 21, that is, an opposite facing portion (first opposite facing portion 11FA) of the first spiral conductor portion 11 with respect to the second spiral conductor portion 21. In FIG. 8, end portions on the Z1 side in the Z1-Z2 direction of the first inner-side turn 111, the first central turn 112, and the first outer-side turn 113, as well as an end portion on the Z1 side in the Z1-Z2 direction of the first lead-out portion 14 connected to the first outer-side turn 113 are the first opposite facing portion 11FA, and the second insulator portion 80 is provided on this first opposite facing portion 11FA.

The second insulator portion 80 has a portion in contact with an opposite facing portion (second opposite facing portion 21FA) of the second spiral conductor portion 21 with respect to the first spiral conductor portion 11. In FIG. 8, end portions on the Z2 side in the Z1-Z2 direction of the second inner-side turn 211, the second central turn 212, and the second outer-side turn 213 are the second opposite facing portion 21FA, and the second insulator portion 80 has a portion in contact with this second opposite facing portion 21FA.

The second insulator portion 80 has a portion in contact with a side portion of the first spiral conductor portion 11 along the spiral direction. To specifically explain the side portion using the first inner-side turn 111, the first inner-side turn 111 has a side portion facing the inner peripheral side (X1 side in X1-X2 direction) and a side portion facing the outer peripheral side (X2 side in X1-X2 direction) and opposing the first central turn 112. The second insulator portion 80 has portions in contact with these side portions. As shown in FIG. 4, the second insulator portion 80 is not provided on the side portion on the outer peripheral side (X2 side in X1-X2 direction) of the outer-side end part 13 of the first spiral conductor portion 11 (first lead-out portion end face 14E) so as to allow electrical connection with another member (first external electrode 41).

The second insulator portion 80 has a portion in contact with a side portion of the second spiral conductor portion 21 along the spiral direction. To specifically explain the side portion using the second inner-side turn 211, the second inner-side turn 211 has a side portion facing the inner peripheral side (X1 side in X1-X2 direction) and a side portion facing the outer peripheral side (X2 side in X1-X2 direction) and opposing the second central turn 212. The second insulator portion 80 has portions in contact with these side portions. As shown in FIG. 4, the second insulator portion 80 is not provided on the side portion on the outer peripheral side (X1 side in X1-X2 direction) of the outer-side end part 23 of the second spiral conductor portion 21 (second lead-out portion end face 24E) so as to allow electrical connection with another member (second external electrode 42).

From the viewpoint of stably providing the second insulator portion 80 on the side portions, an average width of gaps between two turns arranged in a direction (XY in-plane direction) intersecting the first direction (Z1-Z2 direction) may preferably be 0.025 times or more and 0.25 times or less an average value of widths of the two turns in the arranged direction.

An average value of a thickness of a portion of the second insulator portion 80 in contact with the first opposite facing portion 11FA (opposite facing portion of the first spiral conductor portion 11 with respect to the second spiral conductor portion 21), a thickness of a portion in contact with the second opposite facing portion 21FA (opposite facing portion of the second spiral conductor portion 21 with respect to the first spiral conductor portion 11), a thickness of a portion in contact with the side portion of the first spiral conductor portion 11, and a thickness of a portion in contact with the side portion of the second spiral conductor portion 21 may preferably be 0.2 μm or more and 10 μm or less from the viewpoint that the second insulator portion 80 has good insulating properties. From the viewpoint of more stably ensuring insulation, this average value is more preferably 1.0 μm or more.

The second insulator portion 80 has a first connection portion 801 positioned so as to connect a portion in contact with a side portion of a first turn that is at least one of the turns of the first spiral conductor portion 11 (in this embodiment, first inner-side turn 111, first central turn 112, and first outer-side turn 113) and a portion in contact with a side portion of a second turn in the second spiral conductor portion 21 that is closest to the side portion of the first turn. By having the first connection portion 801, it becomes easy to enhance the insulation between the first spiral conductor portion 11 and the second spiral conductor portion 21. From the viewpoint that the first connection portion 801 is stably formed, it may be preferable that the average value of the clearance in the first direction (Z1-Z2 direction) between the first spiral conductor portion 11 and the second spiral conductor portion 21 is 0.4 μm or more and 20 μm or less.

Taking a case where the first turn is the first inner-side turn 111 as a specific example, the second turn in the second spiral conductor portion 21 that is closest to the side portion of the first turn (first inner-side turn 111) is the second inner-side turn 211. The second insulator portion 80 in contact with the side portion on the inner peripheral side (X1 side in X1-X2 direction) of the first inner-side turn 111 also contacts the non-contact portion EP, which is a portion where the first insulator portion 90 does not contact the first facing portion 11F, located at an end portion on the inner peripheral side (X1 side in X1-X2 direction) of the first facing portion 11F. On the other hand, the second insulator portion 80 in contact with the side portion on the inner peripheral side (X1 side in X1-X2 direction) of the second inner-side turn 211 also contacts the non-contact portion EP, which is a portion where the first insulator portion 90 does not contact the second facing portion 21F, located at an end portion on the inner peripheral side (X1 side in X1-X2 direction) of the second facing portion 21F. The second insulator portion 80 positioned to connect the second insulator portion 80 in contact with the inner peripheral side (X1 side in X1-X2 direction) of the first inner-side turn 111 and the second insulator portion 80 in contact with the inner peripheral side (X1 side in X1-X2 direction) of the second inner-side turn 211 is the first connection portion 801.

Furthermore, FIG. 8 illustrates a first connection portion 801 connecting the second insulator portion 80 in contact with the side portion on the outer peripheral side (X2 side in X1-X2 direction) of the first inner-side turn 111 and the first facing portion 11F, and the second insulator portion 80 in contact with the side portion on the outer peripheral side (X2 side in X1-X2 direction) of the second inner-side turn 211 and the second facing portion 21F; a first connection portion 801 connecting the second insulator portion 80 in contact with the side portion on the inner peripheral side (X1 side in X1-X2 direction) of the first central turn 112 and the first facing portion 11F, and the second insulator portion 80 in contact with the side portion on the inner peripheral side (X1 side in X1-X2 direction) of the second central turn 212 and the second facing portion 21F; a first connection portion 801 connecting the second insulator portion 80 in contact with the side portion on the outer peripheral side (X2 side in X1-X2 direction) of the first central turn 112 and the first facing portion 11F, and the second insulator portion 80 in contact with the side portion on the outer peripheral side (X2 side in X1-X2 direction) of the second central turn 212 and the second facing portion 21F; and a first connection portion 801 connecting the second insulator portion 80 in contact with the side portion on the inner peripheral side (X1 side in X1-X2 direction) of the first outer-side turn 113 and the first facing portion 11F, and the second insulator portion 80 in contact with the side portion on the inner peripheral side (X1 side in X1-X2 direction) of the second outer-side turn 213 and the second facing portion 21F.

In this way, by having the first connection portion 801, the volume of the coil insulator portion can be reduced, which makes it easy to enhance electrical characteristics of the coil component 100 and to meet the demand for miniaturization of the coil component 100.

The second insulator portion 80 in contact with the side portion on the outer peripheral side (X2 side in X1-X2 direction) of the second outer-side turn 213 has a second connection portion 802 that is a portion connecting the second insulator portion 80 in contact with a first extending portion 14P, which is a portion on the Z2 side in the Z1-Z2 direction of the first lead-out portion 14 and extending from the first facing portion 11F of the first outer-side turn 113, and the second insulator portion 80 in contact with the side portion on the outer peripheral side (X2 side in X1-X2 direction) of the second outer-side turn 213 and the second facing portion 21F. This second connection portion 802 is also provided between the second insulator portion 80 in contact with the side portion on the outer peripheral side (X1 side in X1-X2 direction) of the first outer-side turn 113 and the second insulator portion 80 in contact with a portion on the Z1 side in the Z1-Z2 direction of the second lead-out portion 24.

The second insulator portion 80 shown in FIG. 8 contacts a portion of the coil conductor portion 20 located inside the main body portion 30. Specifically, the second insulator portion 80 is provided so as to contact portions other than an outer (X2 side in X1-X2 direction) end portion (first lead-out portion end face 14E) of the first lead-out portion 14 and an outer (X1 side in X1-X2 direction) end portion (second lead-out portion end face 24E, not shown in FIG. 8) of the second lead-out portion 24 in the coil conductor portion 20. As a result, even if the surface of the magnetic powder contained in the main body portion 30 has conductivity, an unexpected short circuit is reliably avoided in the coil conductor portion 20 resulting from contact between the coil conductor portion 20 and the magnetic powder. As will be described later, a first external electrode 41 is provided to be in electrical contact with the first lead-out portion end face 14E, and a second external electrode 42 is provided to be in electrical contact with the second lead-out portion end face 24E.

From the viewpoint of more reliably preventing short circuit inside the coil conductor portion 20, the second insulator portion 80 in contact with the first spiral conductor portion 11 preferably contacts the turn in a continuous manner without a connection boundary among these portions: a portion in contact with an opposing portion (first facing portion 11F) facing the second spiral conductor portion 21, a portion in contact with an opposite facing portion (first opposite facing portion 11FA) with respect to the second spiral conductor portion 21, and a portion in contact with a side surface, for all turns of the first spiral conductor portion 11. Similarly, the second insulator portion 80 in contact with the second spiral conductor portion 21 preferably contacts the turn continuously without a connection boundary among a portion in contact with an opposing portion (second facing portion 21F) facing the first spiral conductor portion 11, a portion in contact with an opposite facing portion (second opposite facing portion 21FA) with respect to the first spiral conductor portion 11, and a portion in contact with a side surface, for all turns of the second spiral conductor portion 21.

### (Main Body Portion)

The main body portion 30 includes a magnetic powder and encloses a part of the coil portion 10. In this embodiment, the main body portion 30 has a substantially rectangular cuboid shape and encloses portions excluding the outermost (X2 side in X1-X2 direction) end face of the first lead-out portion 14 and the outermost (X1 side in X1-X2 direction) end face of the second lead-out portion 24 located at the end portions of the coil portion 10.

The structure of the magnetic powder is not limited. This structure may include a crystalline phase or an amorphous phase. Here, a crystalline material is defined as a material composed of a crystalline phase, an amorphous material is defined as a material composed of an amorphous phase, and a composite material is defined as a material composed of a crystalline phase and an amorphous material. When a diffraction spectrum obtained by a conventional X-ray diffraction method includes a sharp diffraction peak capable of identifying the type of crystalline phase, the material includes a crystalline phase. Furthermore, when a diffraction spectrum obtained by a conventional X-ray diffraction method includes a broad peak indicating an amorphous phase, the material includes an amorphous phase. The material also includes an amorphous phase when a DSC curve obtained by differential thermal analysis includes a peak indicating crystallization, that is, heat generation associated with a phase change from an amorphous phase to a crystalline phase.

The material system of the magnetic powder is not limited. Specific examples of crystalline materials include Fe—Si—Cr based alloys, Fe—Ni based alloys, Fe—Co based alloys, Fe—V based alloys, Fe—Al based alloys, Fe—Si based alloys, Fe—Si—Al based alloys, pure iron, and ferrite. Carbonyl iron powder is preferable as the pure iron powder. Specific examples of amorphous materials include Fe—Si—B based alloys, Fe—P—C based alloys, and Co—Fe—Si—B based alloys. Specific examples of composite materials include Fe—Zr based alloys, Fe—Zr—B based alloys, Fe—Si—B—Nb—Cu based alloys, and Fe—Si—B—P—Cu based alloys. When the magnetic powder is a metal powder containing Fe, the synergistic effect of improving magnetic properties is particularly significant.

The chemical composition of the magnetic powder is not limited. For example, the Fe—Si—Cr based alloy may consist of 1.0 to 10.0 mass % of Si, 1.0 to 10.0 mass % of Cr, and the balance consisting of Fe and impurities. Also, for example, the Fe—Ni based alloy may consist of 1.0 to 99.0 mass % of Ni, and the balance consisting of Fe and impurities. Furthermore, for example, the Fe—P—C based alloy may consist of 1.0 to 13.0 atomic % of P, 1.0 to 13.0 atomic % of C, and Fe and impurities. This Fe—P—C based alloy may include, as an optional element, one or more selected from the group consisting of Ni, Sn, Cr, B, and Si. In this case, for example, the amount of Ni may be 0 to 10.0 atomic %, the amount of Sn may be 0 to 3.0 atomic %, the amount of Cr may be 0 to 6.0 atomic %, the amount of B may be 0 to 9.0 atomic %, and the amount of Si may be 0 to 7.0 atomic %. The amount of Fe is preferably 65 atomic % or more. Also, for example, the Fe—Si—B—Nb—Cu based alloy may consist of 1.0 to 16.0 atomic % of Si, 1.0 to 15.0 atomic % of B, 0.50 to 5.0 atomic % of Nb, 0.50 to 5.0 atomic % of Cu, and the balance consisting of Fe and impurities. In this case, the amount of Fe is preferably 65 atomic % or more.

The shape of the magnetic powder is not limited. The magnetic powder may be spherical, elliptical, scaly, or may have an irregular shape. The manufacturing method for obtaining these shapes is also not limited.

The particle size distribution of the magnetic powder is not limited. The particle size distribution of the magnetic powder can be obtained, for example, by analyzing an image (secondary electron image) obtained by imaging a cut surface of the main body portion 30 with a scanning electron microscope. For example, the average circle equivalent diameter of the magnetic powder may be 0.50 to 50.0 μm. The distribution of the circle equivalent diameter may include a plurality of peaks.

The magnetic powder may be subjected to a surface insulation treatment. When the magnetic powder is subjected to a surface insulation treatment, the insulation resistance of the main body portion 30 is improved. The type of surface insulation treatment applied to the magnetic powder is not limited. Phosphoric acid treatment, phosphate treatment, oxidation treatment, etc. are exemplified. The magnetic powder may have an insulating coating on the surface of the magnetic particles. This insulating coating may include at least one selected from the group consisting of Si, P, and B, and O (oxygen).

The magnetic powder may be a mixed material in which a plurality of powder materials are mixed. This magnetic powder is preferably a ferromagnetic material, and more preferably a soft magnetic material.

The main body portion 30 may further include any auxiliary materials. Optional auxiliary materials are, for example, a binder material and a modifier. The binder material binds particles such as magnetic powder contained in the main body portion 30 to each other. This binder material is preferably an insulating material in order to impart insulation resistance to the main body portion 30.

The binder material may be an organic material or an inorganic material. The organic material may be a resin material. Examples of resin materials include acrylic resin, silicone resin, epoxy resin, phenol resin, urea resin, melamine resin, and polyester resin. The inorganic material may be a glass-based material such as water glass. The binder material may be a product of a reaction such as thermal decomposition, or may be a mixture of a plurality of materials.

The modifier, for example, improves the fluidity of the powder or adjusts the curing speed of the binder material. The modifier may be a glass-based material.

The dimensions of the main body portion 30 are not limited. For example, the maximum dimension of the main body portion 30 may be 3.2 mm or less.

### (External Electrode)

As shown in FIG. 2, the outermost (X2 side in X1-X2 direction) end face of the first lead-out portion 14 (first lead-out portion end face 14E) and the outermost (X1 side in X1-X2 direction) end face of the second lead-out portion 24 (second lead-out portion end face 24E) located at the end portions of the coil portion 10 are exposed from the main body portion 30 at side surfaces arranged side by side in the X1-X2 direction in the main body portion 30. A first external electrode 41, which is one of a pair of external electrodes, is provided to be in electrical contact with the first lead-out portion end face 14E, and a second external electrode 42, which is the other of the pair of external electrodes, is provided to be in electrical contact with the second lead-out portion end face 24E.

As shown in FIG. 1, the first external electrode 41 has a side surface portion 41a covering a side surface on the X2 side in the X1-X2 direction of the main body portion 30, and a bottom surface portion 41b provided so as to cover a part of a bottom surface (surface on the Z2 side in Z1-Z2 direction) of the main body portion 30. The bottom surface portion 41b is a portion facing a substrate during use. The second external electrode 42 has a side surface portion 42a covering a side surface on the X1 side in the X1-X2 direction of the main body portion 30, and a bottom surface portion 42b provided on the bottom surface of the main body portion 30 so as to cover a part of the bottom surface while being spaced apart from the bottom surface portion 41b. The bottom surface portion 42b is also a portion facing the substrate during use.

The positions of the first external electrode 41 and the second external electrode 42 are not limited to the above-mentioned positions. The first external electrode 41 and the second external electrode 42 may be formed to cover a part of an upper surface (surface on Z1 side in Z1-Z2 direction) of the main body portion 30. Furthermore, the first external electrode 41 and the second external electrode 42 may be provided only on a part of the bottom surface (surface on Z2 side in Z1-Z2 direction) of the main body portion 30. In this case, the coil conductor portion 20 may have a connection conductor portion (not shown) connecting from the two end portions (first lead-out portion end face 14E, second lead-out portion end face 24E) of the coil portion 10 to the bottom surface of the main body portion 30 through the inside of the main body portion 30. In this case, the two end portions of the coil portion 10 (first lead-out portion end face 14E, second lead-out portion end face 24E) may not be exposed on the side surfaces of the main body portion 30, and the connection conductor portion may be exposed on the bottom surface of the main body portion 30.

The materials and configurations of the first external electrode 41 and the second external electrode 42 are not limited as long as they have appropriate conductivity. A non-limiting example of the first external electrode 41 and the second external electrode 42 is a layer having a structure of Cu plating/Ni plating/Sn plating from the side proximal to the surface of the main body portion 30. The first external electrode 41 and the second external electrode 42 may be composed of coating-type electrodes in which a conductive substance such as silver is dispersed in a resin or the like. Moreover, the first external electrode 41 and the second external electrode 42 may be a combination of plating and an coating-type electrode.

### (Outer Cover)

As shown in FIG. 1, insulating outer covers 50, 60 are respectively provided on an upper surface (surface on Z1 side in Z1-Z2 direction) and side surfaces lined up in the Y1-Y2 direction of the main body portion 30. An insulating outer cover may also be provided on a portion of the bottom surface of the main body portion 30 where the bottom surface portions 41b, 42b of the external electrodes are not provided. Also, the coil component 100 may not be provided with the outer covers 50, 60. These outer covers 50, 60 can be formed at arbitrary positions on the surface of the main body portion 30 depending on the purpose.

### (Manufacturing Method)

The method for manufacturing the coil component according to the present embodiment is not particularly limited. As a non-limiting example of the manufacturing method, there is a manufacturing method including forming the first conductor portions 11A, 21A, 14A, 24A by electroplating (electrolytic plating) as follows.

FIGS. 10 to 14 are explanatory diagrams (Part 1 to Part 5) illustrating an example of a method for manufacturing the coil component according to an embodiment of the present invention.

### (a) Preparation of Sheet Substrate

First, as shown in FIG. 10(a), a sheet substrate 91 having a substrate through hole 91H provided at a position corresponding to the via portion VP is prepared. As long as the sheet substrate 91 has mechanical characteristics to function as a support when forming the first spiral conductor portion 11 and the second spiral conductor portion 21, there are no restrictions on the material. It may be preferable that the sheet substrate 91 has appropriate insulating properties required as a raw material for the first insulator portion 90, and the sheet substrate 91 preferably has appropriate removal characteristics at least in part when performing a removal process of the sheet substrate 91 as described later.

The thickness of the sheet substrate 91 is set in consideration of properly functioning as a support when forming the first spiral conductor portion 11 and the second spiral conductor portion 21, and, if necessary, the insulating properties of the first insulator portion 90 derived from the sheet substrate 91 and the removal characteristics of the sheet substrate 91. As a non-limiting example, the thickness of the sheet substrate 91 may be 0.4 μm or more and 20 μm or less. The thickness of this sheet substrate 91 may be 1.0 μm or more, or 5.0 μm or more. Furthermore, in order to further reduce the size of the coil component 100, the thickness of the sheet substrate 91 may be 14.0 μm or less.

Examples of the constituent material of the sheet substrate 91 include an organic material, an inorganic material, and a composite material thereof. Specific examples of the organic material include thermoplastic resins such as polyimide resin and polyethylene resin, thermosetting resins such as epoxy resin and phenol resin, and cellulose. Specific examples of the inorganic material include oxide-based materials such as glass and alumina, metal-based materials such as aluminum and magnesium, and inorganic salt-based materials such as calcium carbonate. A specific example of the composite material is a structure in which powder of an inorganic material is dispersed in a matrix of an organic material.

### (b) Formation of Conductive Layer

Next, the prepared sheet substrate 91 is arranged such that a normal of a main surface thereof faces a first direction (Z1-Z2 direction), and a pattern 11CP of a third conductor portion 11C corresponding to the first conductor portion 11A is formed on one of the main surfaces (surface on the Z1 side in Z1-Z2 direction), and a pattern 21CP of a third conductor portion 21C corresponding to the first conductor portion 21A is formed on the other of the main surfaces (surface on the Z2 side in Z1-Z2 direction) of the sheet substrate 91.

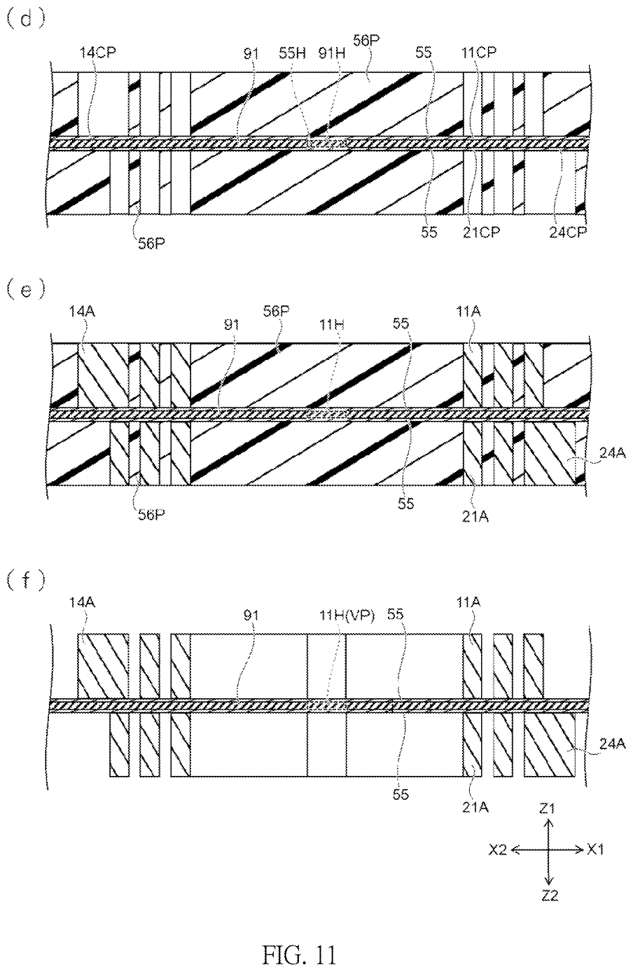

The specific method for forming the pattern 11CP of the third conductor portion 11C and the pattern 21CP of the third conductor portion 21C is not limited. For example, methods shown in FIG. 10(b) to FIG. 11(d) are exemplified. First, as shown in FIG. 10(b), a conductive layer 55 made of the same material as the third conductor portion 11C and the third conductor portion 21C is formed on both surfaces (surfaces on both sides in Z1-Z2 direction) of the sheet substrate 91. The formation method of the conductive layer 55 is not limited. The conductive layer 55 may be formed by a dry process such as sputtering, or may be formed by a wet process such as electroless plating. From the viewpoint of reducing the thickness of the conductive layer 55, it is preferable that the conductive layer 55 is formed by sputtering.

In this example, as shown in FIG. 10(b), a conductive layer 55H is also formed on an inner wall of the substrate through hole 91H. Note that a member in which the conductive layers 55 are previously provided on both surfaces of the sheet substrate 91, such as a copper-clad laminate, may be prepared, and the substrate through hole 91H may be provided in this. In this case, the material of the sheet substrate 91 may be exposed on the inner wall of the substrate through hole 91H, or a process of separately providing the conductive layer 55H may be performed.

### (c) Formation of Insulating Layer

Next, as shown in FIG. 10(c), an insulating layer 56 made of a patternable material such as a dry film resist is laminated on each of the conductive layers 55 provided on both surfaces of the sheet substrate 91. The thickness of each insulating layer 56 is formed to be thicker than the thickness of the first conductor portion 11A and thicker than the thickness of the first conductor portion 21A, whereby the shape controllability of the first conductor portion 11A and the first conductor portion 21A can be improved.

### (d) Formation of Pattern of Conductive Layer

Subsequently, an exposure and development process is performed on the insulating layers 56 on both sides in the Z1-Z2 direction, and a part of the insulating layers 56 is removed to form a negative pattern 56P having respective inverted shapes of the pattern 11CP of the third conductor portion 11C corresponding to the first conductor portion 11A and the pattern 21CP of the third conductor portion 21C corresponding to the first conductor portion 21A. Thereby, parts of the conductive layers 55 on both sides in the Z1-Z2 direction are exposed, and as shown in FIG. 11(d), the pattern 11CP of the third conductor portion 11C and the pattern 21CP of the third conductor portion 21C are formed.

When exposing and developing the insulating layers 56 on both sides in the Z1-Z2 direction, by removing portions corresponding to the third conductor portion 14C of the first lead-out portion 14 and the third conductor portion 24C of the second lead-out portion 24, the negative pattern 56P on the Z1 side in the Z1-Z2 direction can form a pattern 14CP of the third conductor portion 14C, and the negative pattern 56P on the Z2 side in the Z1-Z2 direction can form a pattern 24CP of the third conductor portion 24C. As a result, as shown in FIG. 11(d), the pattern 14CP of the third conductor portion 14C corresponding to the first conductor portion 14A is formed continuously with the pattern 11CP of the third conductor portion 11C corresponding to the first conductor portion 11A, and the pattern 24CP of the third conductor portion 24C corresponding to the first conductor portion 24A is formed continuously with the pattern 21CP of the third conductor portion 21C corresponding to the first conductor portion 21A.

### (e) Formation of First Conductor Portion

Thus, after the pattern 11CP of the third conductor portion 11C and the pattern 14CP of the third conductor portion 14C, as well as the pattern 21CP of the third conductor portion 21C and the pattern 24CP of the third conductor portion 24C are formed, a first plating process is performed. In the first plating process, an electric current is applied to the conductive layers 55 provided on both surfaces of the sheet substrate 91, and first conductor portions 11A, 14A, 21A, 24A are formed on the patterns of the conductive layer 55 by an electroplating process (FIG. 11(e)).

As described above, since the negative pattern 56P formed from the insulating layer 56 is disposed on the periphery of the patterns 11CP, 14CP, 21CP, 24CP of the conductive layer 55, in the first plating process, by performing an electroplating process using the negative pattern 56P as a masking material, the first conductor portion 11A and the first conductor portion 14A are integrally formed corresponding to the patterns 11CP, 14CP, 21CP, 24CP of the conductive layer 55, and the first conductor portion 21A and the first conductor portion 24A are integrally formed. Further, in the first plating process, a via conductor portion 11H is formed so as to fill the substrate through hole 91H. Since this via conductor portion 11H constitutes the via portion VP, the via portion VP is formed integrally with both the first spiral conductor portion 11 and the second spiral conductor portion 21 in the first plating process.

A plating deposit formed by electroplating is not limited as long as it has appropriate conductivity. As mentioned above, materials containing Cu such as Cu and Cu alloys are non-limiting examples.

### (f) Removal of Negative Pattern

Thus, after the first conductor portions 11A, 21A, 14A, 24A are formed on both surfaces of the sheet substrate 91, a peeling process for peeling off the negative pattern 56P made of the insulating layer 56 is performed. As a result, as shown in FIG. 11(f), a structure is obtained in which the conductive layer 55 is located over the entire surface of the sheet substrate 91 except for the substrate through hole 91H, and the first conductor portions 11A, 21A, 14A, 24A are disposed on the conductive layer 55. As described above, the first conductor portion 11A and the first conductor portion 21A are electrically connected by the via conductor portion 11H constituting the via portion VP.

### (g) Removal of Conductive Layer

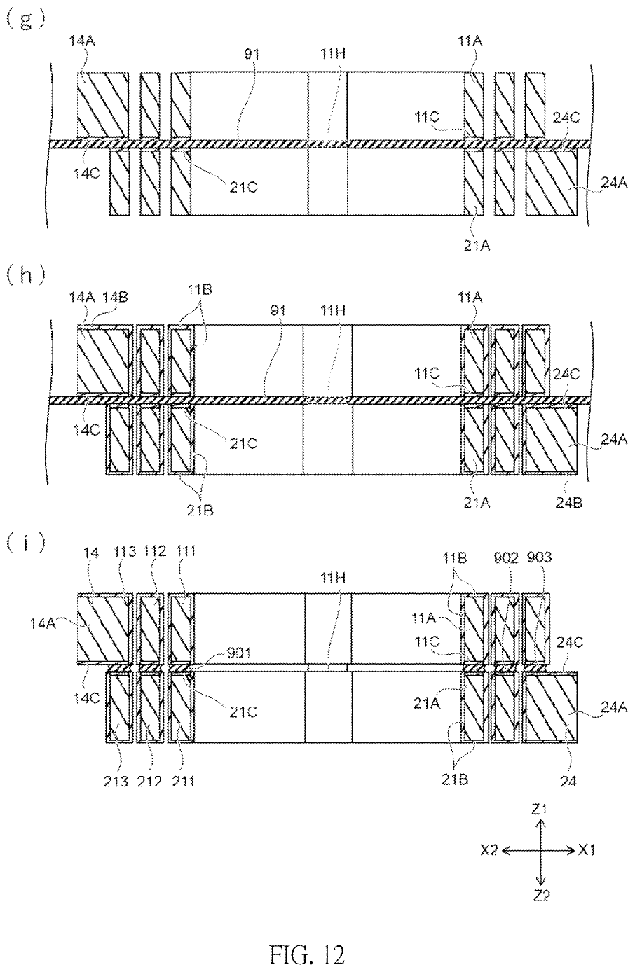

Subsequently, as a part of the removing process, a portion of the conductive layer 55 on the sheet substrate 91 exposed in the first direction (Z1-Z2 direction), specifically a portion not covered by the first conductor portions 11A, 21A, 14A, 24A, is removed. As a result, as shown in FIG. 12(g), the conductive layer 55 remaining on the sheet substrate 91 serves as the third conductor portions 11C, 14C, 21C, 24C serving as components of the coil portion 10.

The removal method of the conductive layer 55 is not limited. A process capable of removing the material constituting the conductive layer 55 and having little effect on the first conductor portions 11A, 21A, 14A, 24A may be appropriately selected. For example, when the first conductor portions 11A, 21A, 14A, 24A are made of Cu and the conductive layer 55 is made of Ni, the portions of the conductive layer 55 not covered by the first conductor portions 11A, 21A, 14A, 24A can be etched with high selectivity. When the constituent material of the conductive layer 55 is the same type as the first conductor portions 11A, 21A, 14A, 24A, the first conductor portions 11A, 21A, 14A, 24A are also partially removed by the process capable of removing the material constituting the conductive layer 55, but the shape of the electroplating deposit formed in the first plating process step may be a shape considering this removed amount.

### (h) Formation of Second Conductor Portion

By removing the conductive layer 55 as described above, conductive members exposed on the sheet substrate 91 become substantially only the first conductor portions 11A, 21A, 14A, 24A. In this state, by performing a second plating process, second conductor portions 11B, 21B are formed on surfaces of the first conductor portions 11A, 21A, and second conductor portions 14B, 24B are formed on surfaces of the first conductor portions 14A, 24A. The second plating process may be an electroplating (electrolytic plating) process or an electroless plating process.

### (i) Removal of Sheet Substrate

Subsequently, a removal process is performed to remove an exposed portion where the conductive members are not provided in the sheet substrate 91. Specifically, as shown in FIG. 12(i), the sheet substrate 91 is removed so as to include a region enclosed by the inner edge of the first spiral conductor portion 11 in the sheet substrate 91 when viewed in the first direction (Z1-Z2 direction). In FIG. 12(i), among the sheet substrate 91, a part between the first inner-side turn 111 and the second inner-side turn 211, a part between the first central turn 112 and the second central turn 212, and a part between the first outer-side turn 113 and the second outer-side turn 213 are unremoved as residues, forming first insulator portions 901, 902, 903, respectively.

The specific removal process of the sheet substrate 91 is appropriately set according to the constituent material of the sheet substrate 91. The removal process is broadly classified into a dry process such as plasma etching and a wet process such as wet etching. Wet etching, which is an isotropic removal process, is preferable from the viewpoint of preventing the sheet substrate 91 from remaining in the region surrounded by the inner edge of the first spiral conductor portion 11 or appropriately forming the non-contact portion EP shown in FIG. 9 and the like. Moreover, a wet process may also be preferable from the viewpoint of increasing the removal efficiency of the sheet substrate 91. A part of the sheet substrate 91 may be removed by the removal process, and there may be a remaining unremoved portion. For example, the sheet substrate 91 may be composed of a composite material of an organic material and an inorganic material, and only the organic material may be removed in the removal process.

### (j) Formation of Second Insulator Portion

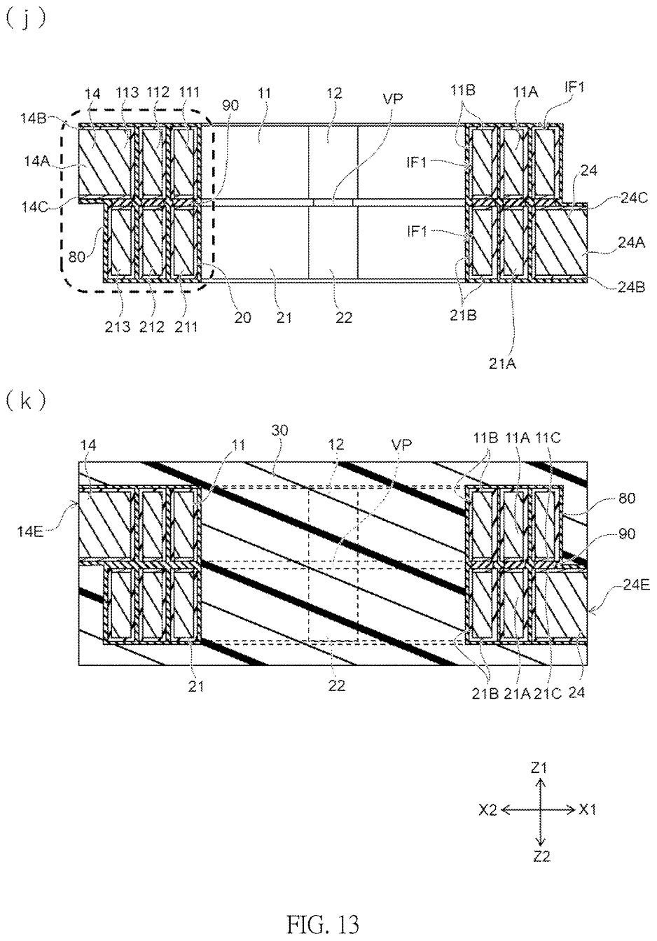

When the sheet substrate 91 is removed in this way, a second insulator portion 80 made of an insulating material is formed so as to cover at least a part of exposed portions of the coil conductor portion 20. In FIG. 13(j), the second insulator portion 80 is provided on exposed surfaces of the first spiral conductor portion 11 and the second spiral conductor portion 21 constituting the coil conductor portion 20, as well as an exposed surface other than a surface facing the X1-X2 direction of the first lead-out portion 14 and an exposed surface other than a surface facing the X1-X2 direction of the second lead-out portion 24. External electrodes (first external electrode 41, second external electrode 42) are provided on the surfaces where the second insulator portion 80 is not provided.

The formation process of the second insulator portion 80 is appropriately set according to the constituent material of the second insulator portion 80. For example, when the second insulator portion 80 is made of a parylene-based polymer, it is formed by a dry process (vapor deposition). When the second insulator portion 80 contains a curable resin material such as epoxy resin, it can be formed by attaching a powder or a liquid containing the constituent material of the second insulator portion 80 to the exposed surface, and then solidifying the attached matter by heating or the like.

### (k) Formation of Main Body Portion

When the coil portion 10 is formed by the above steps, as shown in FIG. 13(k), the main body portion 30 is formed by sealing a part of the first lead-out portion 14 and the second lead-out portion 24 in the coil portion 10, specifically portions other than the first lead-out portion end face 14E and the second lead-out portion end face 24E as a specific example in this embodiment, with a material containing magnetic powder. The formation method of the main body portion 30 is not limited, and a molding process is exemplified. Specific examples of the molding process include arranging the product shown in FIG. 13(j) in a mold and forming it by compression molding of a material containing magnetic powder, or transfer molding a material containing magnetic powder or a member serving as a raw material for the material. When the product shown in FIG. 13(j) is placed in a mold and compression-molded to obtain the product shown in FIG. 13(k), increasing the uniformity of the thickness (height in the first direction) of the spiral conductor portions (first spiral conductor portion 11, second spiral conductor portion 21) in the coil portion 10 in the product shown in FIG. 13(j) is preferable from the viewpoint of improving molding quality (quality of the product shown in FIG. 13(k), specifically its thickness uniformity is exemplified).

The method for forming the main body portion 30 such that the first lead-out portion end face 14E and the second lead-out portion end face 24E are exposed from the main body portion 30 is not limited. For example, the main body portion 30 may be formed after masking the first lead-out portion end face 14E and the second lead-out portion end face 24E. Alternatively, it can also be formed by providing dummy members continuously so as to cover or integrally connect the first lead-out portion end face 14E and the second lead-out portion end face 24E, forming the second insulator portion 80 on the surface of the dummy members, then forming the main body portion 30, and thereafter cutting the dummy members to expose the first lead-out portion end face 14E and the second lead-out portion end face 24E.

### (l) Formation of Outer Cover

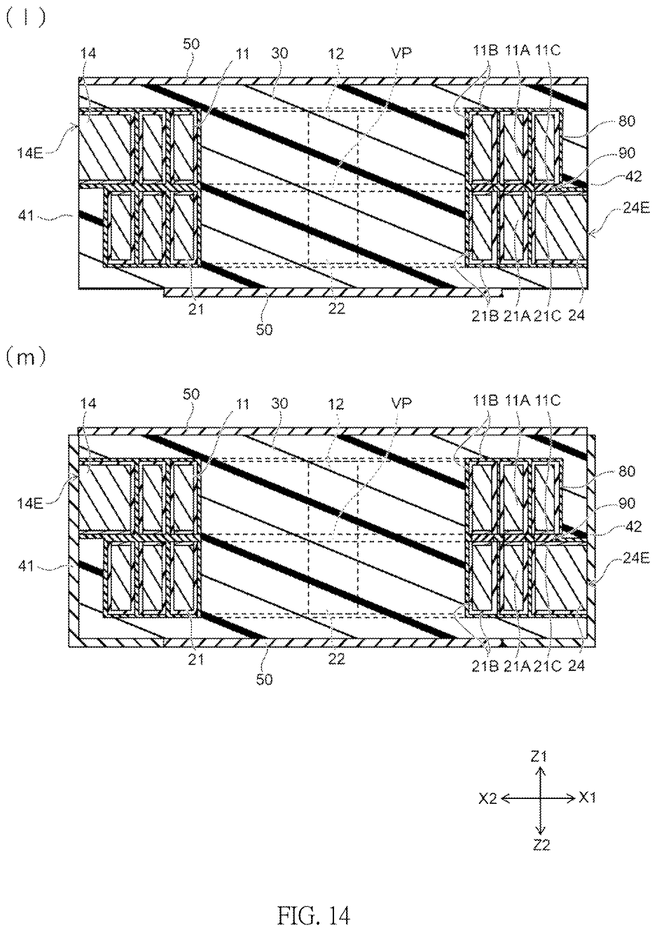

Next, an outer cover 50 is applied to a part of exposed portions of the main body portion 30, which are portions where neither the first external electrode 41 nor the second external electrode 42 is formed on an upper surface (surface on the Z1 side in Z1-Z2 direction) and a lower surface (surface on the Z2 side in Z1-Z2 direction) of the main body portion 30 in FIG. 14(l), to protect the main body portion 30. Although not shown in FIG. 14(l), an outer cover 60 is also applied together with the outer cover 50. Although the main body portion 30 may be left as it is, when an external force is applied based on collisions with other members, the insulating coating on the surface of the magnetic powder constituting the main body portion 30 may be scraped off, which may lower the resistance of the surface of the main body portion 30. Since a decrease in surface insulation may cause a decrease in reliability of the coil component 100, it is preferable to provide outer covers 50, 60 made of an insulating material. The formation method of the outer covers 50, 60 is not limited. Known methods such as printing and coating may be employed. The constituent material of the outer covers 50, 60 may be a known material such as an epoxy resin, and from the viewpoint of improving impact resistance, a composite material in which an inorganic material such as glass fiber is dispersed in an organic material such as an epoxy resin may be preferable in some cases. Furthermore, the outer covers 50, 60 may be formed for the purpose of improving appearance quality or improving the positional accuracy of the external electrodes (e.g., prevention of plating spread) formed in the next step, in addition to improving insulation reliability and impact resistance. Note that this outer cover formation process may be repeated multiple times, and in that case, the outer cover 50 and the outer cover 60 may be formed by different processes.

### (m) Formation of External Electrode

Finally, one of two terminal portions (first external electrode 41) is electrically connected to a part of the first lead-out portion 14 (first lead-out portion end face 14E) that was not sealed with the material containing magnetic powder when forming the main body portion 30, and the other of the two terminal portions (second external electrode 42) is electrically connected to a part of the second lead-out portion 24 (second lead-out portion end face 24E). The method for forming the first external electrode 41 and the second external electrode 42 is not limited, and a plating process and a printing process are exemplified. In FIG. 14(m), the first external electrode 41 and the second external electrode 42 are formed to extend not only to side surfaces (surfaces facing the X1-X2 direction) of the main body portion 30 but also to a part of the bottom surface (surface on the Z2 side in Z1-Z2 direction) of the main body portion 30. As described above, by forming the external electrodes (first external electrode 41 and second external electrode 42) after forming the outer cover 50, it is possible to prevent a problem (plating spread) in which a plating deposit is formed in an unexpected region on the exposed surface of the main body portion 30, thereby lowering the shape accuracy of the external electrodes or increasing the risk of short-circuiting of the external electrodes. From this viewpoint, it is preferable that the outer cover 50 is also formed on the lower surface (Z2 side in Z1-Z2 direction) serving as a mounting surface in the outer cover formation process, as in the present embodiment.

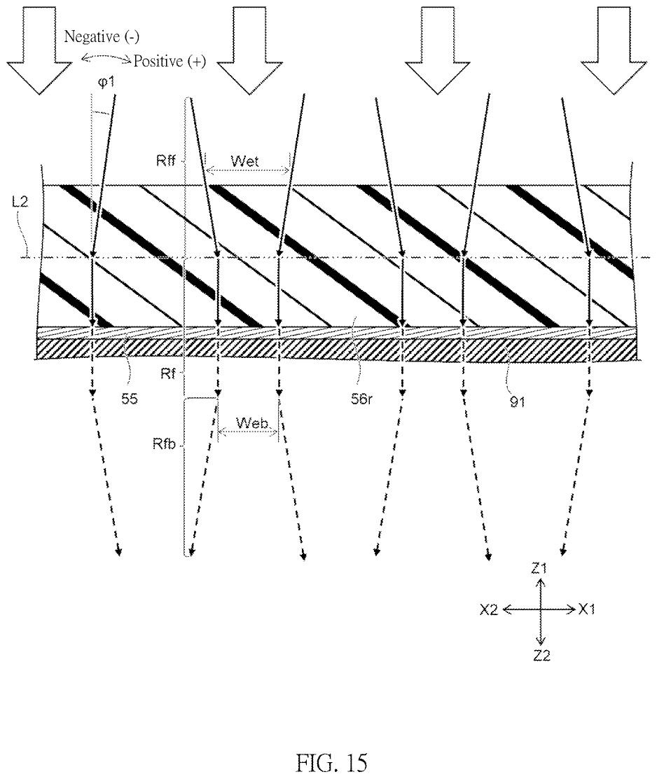

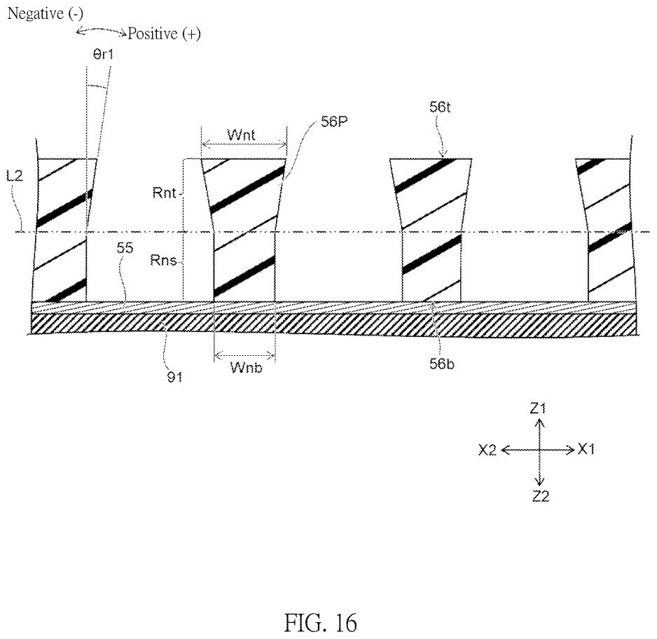

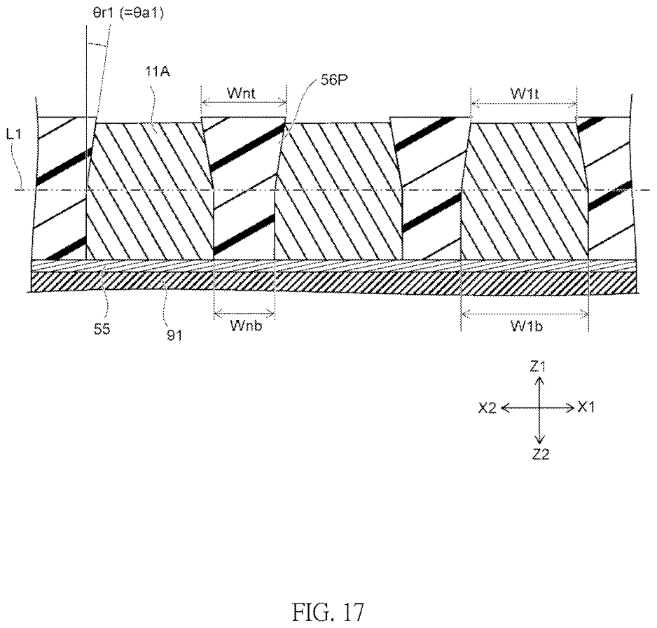

FIG. 15 is a detailed diagram illustrating an example of a method for manufacturing a coil component (exposure process) according to an embodiment of the present invention, FIG. 16 is a detailed diagram illustrating an example of the method for manufacturing a coil component (after development process) according to an embodiment of the present invention, and FIG. 17 is a detailed diagram illustrating an example of the method for manufacturing a coil component (after first plating process) according to an embodiment of the present invention, and these are diagrams for explaining in detail the manufacturing process explained with reference to FIG. 11(d) to FIG. 12(g).

In the method for manufacturing the coil component 100 according to this embodiment, the insulating layer 56 formed in FIG. 10(c) is formed from a negative resist (dry film resist) 56r in which an exposed portion is cured, as shown in FIG. 15. Then, exposure is performed such that a part of the insulating layer 56 (negative resist 56r) distal from the sheet substrate 91, that is, a part on the Z1 side in the Z1-Z2 direction in FIG. 15, is located in a region in front of a depth of focus Rf (front region Rff). The light passing through the depth of focus Rf has an optical path substantially along the Z1-Z2 direction, but the light passing through the front region Rff has an optical path that converges toward the depth of focus Rf located on the Z2 side in the Z1-Z2 direction. Note that in a region behind the depth of focus Rf (rear region Rfb), the light has an optical path diverging from the depth of focus Rf. In FIG. 15, a virtual line L2 is shown as a boundary between the depth of focus Rf and the front region Rff to facilitate understanding, but the boundary between the depth of focus Rf and the front region Rff may instead be a continuous region in the Z1-Z2 direction.

As described above, in the portion of the insulating layer 56 (negative resist 56r) located in the front region Rff, exposure is performed such that an exposure region becomes narrower in the X1-X2 direction from the Z1 side in the Z1-Z2 direction toward the Z2 side in the Z1-Z2 direction. FIG. 15 shows that an end portion of the exposure region in the X1-X2 direction forms a predetermined angle $1 with respect to the first direction. On the other hand, in the portion of the insulating layer 56 (negative resist 56r) located at the depth of focus Rf, exposure along the Z1-Z2 direction is performed. Therefore, a width Web on a side proximal to the sheet substrate 91 in the exposure region becomes narrower than a width Wet on a distal side.

The negative pattern 56P obtained by development based on this exposure has a stripe portion in which a plurality of lines are arranged in a second direction (X1-X2 direction), which is one of the in-plane directions of the main surface of the sheet substrate 91, as shown in FIG. 16. As described above, this stripe portion is formed by exposing a sheet-like negative resist 56r provided on the main surface of the sheet substrate 91 such that a part distal from the sheet substrate 91 (a part on the Z1 side in Z1-Z2 direction) is located in the front region Rff which is a region in front of the depth of focus Rf.

Among the negative pattern 56P, a development surface formed on a line of the stripe portion by development, that is, a surface facing the X1-X2 direction formed by development, has a negative taper region Rnt whose width in the X1-X2 direction increases in a direction away from the sheet substrate 91 at a portion located in the front region Rff, and an average inclination angle θr1 of the negative taper region Rnt based on the angle φ1 in exposure has a positive value. Further, the negative pattern 56P has a negative straight region Rns whose width in the X1-X2 direction is substantially along the Z1-Z2 direction at a portion located in the depth of focus Rf. Therefore, a width Wnb of a bottom surface 56b proximal to the sheet substrate 91 in the negative pattern 56P becomes narrower than a width Wnt of a top surface 56t distal from the sheet substrate 91.

From the viewpoint of efficiently forming such a negative pattern 56P, a length of the depth of focus Rf in the first direction is preferably 35% or more of the first conductor portion thickness T1 shown in FIG. 5A, and more preferably 60% or more. The upper limit of the depth of focus Rf is not particularly limited, but since an inclination angle of the optical path in the front region Rff tends to be shallow when the depth of focus Rf is excessively long, it may be preferable that the length of the depth of focus Rf in the first direction is 90% or less of the first conductor portion thickness T1. The thickness of the negative pattern 56P is generally set to about 1.1 to 1.3 times the first conductor portion thickness T1 from the viewpoint of ensuring shape stability of the first conductor portion 11A.

Once the negative pattern 56P is thus formed, a first plating process is performed to deposit the first conductive material on the conductive layer 55 exposed laterally (X1-X2 direction) to the negative pattern 56P. In this case, since the deposited first conductive material grows in the Z1-Z2 direction, the first conductor portion 11A made of the first conductive material has a crystal growth direction of a metallic material along the Z1-Z2 direction. When the first conductive material grows, its growth in the X1-X2 direction is suppressed by the negative pattern 56P, so as a result, the shape of the first conductor portion 11A in the X1-X2 direction becomes a shape onto which the shape of the negative pattern 56P in the X1-X2 direction is transferred. Therefore, an average inclination angle θa1 made by the taper region Rt of the first conductor portion 11A with respect to the first direction is equal to the average inclination angle θr1 made by the negative pattern 56P with respect to the first direction. Corresponding to the width Wnb of the bottom surface 56b of the negative pattern 56P being narrower than the width Wnt of the top surface 56t, the width W1b of the first bottom surface 11Ab is wider than the width W1t of the first top surface 11At. As described above, in the first conductor portion 11A having such a taper region Rt and a straight region Rs, it is easy to make the cross section of the turn formed by a subsequent process including the second plating process close to an ideal quadrangular shape.

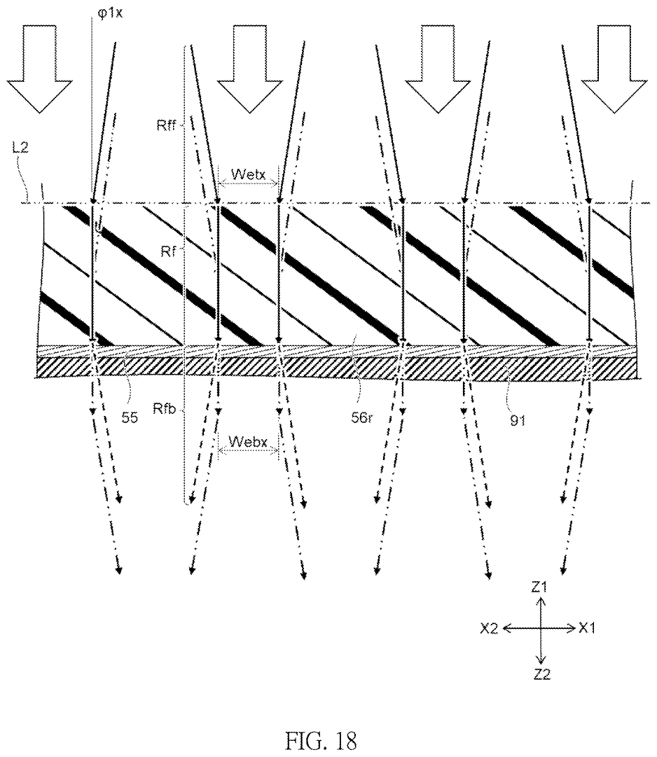

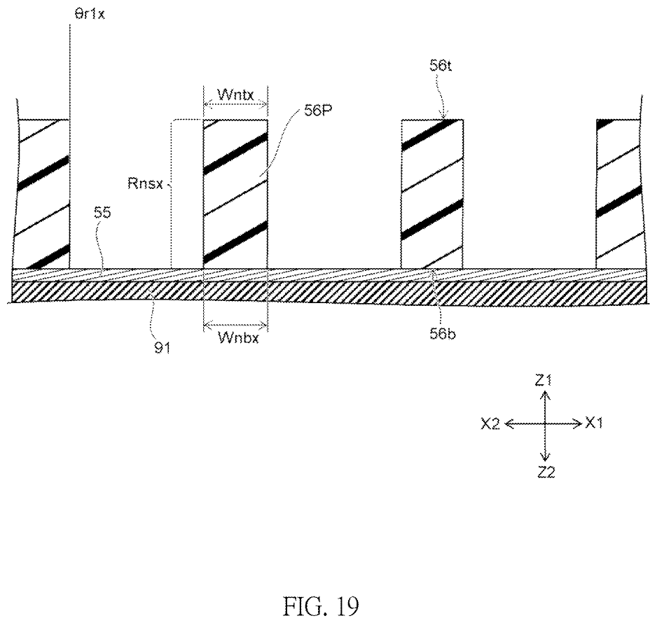

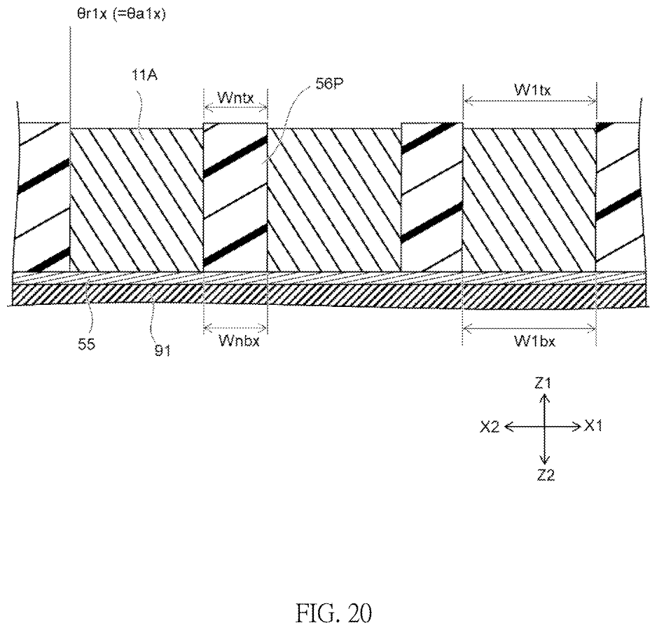

FIG. 18 is a detailed diagram illustrating an example of a method for manufacturing a coil component (exposure process) according to a conventional technique (No. 1), FIG. 19 is a detailed diagram illustrating an example of the method for manufacturing a coil component (after development process) according to the conventional technique (No. 1), and FIG. 20 is a detailed diagram illustrating an example of the method for manufacturing a coil component (after first plating process) according to the conventional technique (No. 1).

In the manufacturing method according to the conventional technique (No. 1), in comparison with the method for manufacturing the coil component 100 according to this embodiment, the position of the depth of focus Rf in the exposure process is different. Specifically, as shown in FIG. 18, exposure is performed so that the entire region of the insulating layer 56 (negative resist 56r) in the Z1-Z2 direction is located in the depth of focus Rf. The two-dot chain line in FIG. 18 indicates the optical path of the exposure process in this embodiment. Since the exposure is performed in this manner, a width Webx on a side proximal to the sheet substrate 91 in an exposure region is substantially equal to a width Wetx on a distal side.

The negative pattern 56P obtained by development based on this exposure becomes a negative straight region Rnsx whose width in the X1-X2 direction is substantially along the Z1-Z2 direction over the entire region in the Z1-Z2 direction, as shown in FIG. 19. Therefore, a width Wnbx of a bottom surface 56b of the negative pattern 56P is substantially equal to a width Wntx of a top surface 56t.

Once the negative pattern 56P is thus formed, a first plating process is performed to deposit the first conductive material on the conductive layer 55 exposed laterally (X1-X2 direction) to the negative pattern 56P. Since the shape of the first conductor portion 11A in the X1-X2 direction becomes a shape onto which the shape of the negative pattern 56P in the X1-X2 direction is transferred, an average inclination angle θa1x made by the straight region Rs of the first conductor portion 11A with respect to the first direction is equal to an average inclination angle θr1x made by the negative pattern 56P with respect to the first direction, and is approximately 0 degrees. Corresponding to the width Wnbx of the bottom surface 56b of the negative pattern 56P being substantially equal to the width Wntx of the top surface 56t, the width W1b of the first bottom surface 11Ab is substantially equal to the width W1t of the first top surface 11At. As described above, in the first conductor portion 11A having only such a straight region Rs, it is difficult to make the cross section of a turn formed by a subsequent process including the second plating process close to an ideal quadrangular shape.

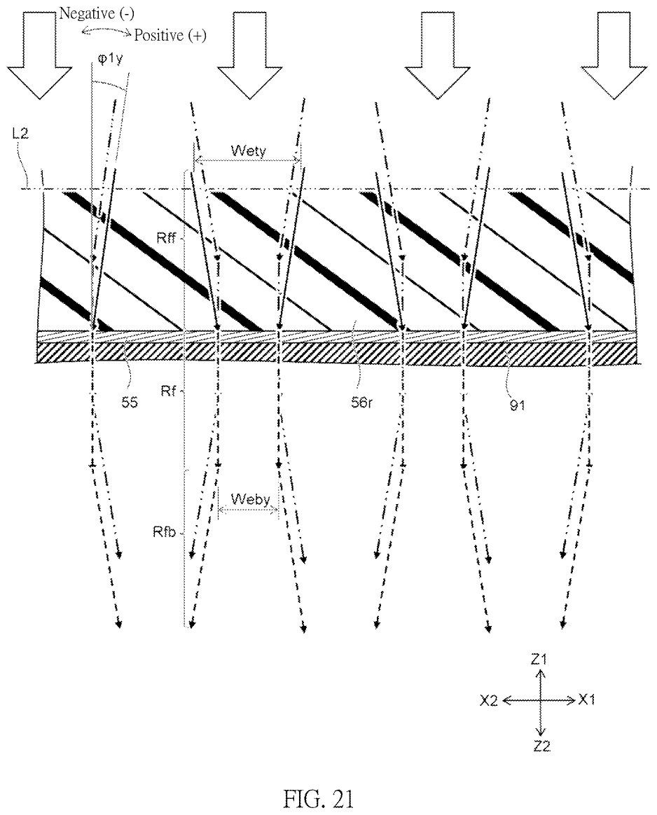

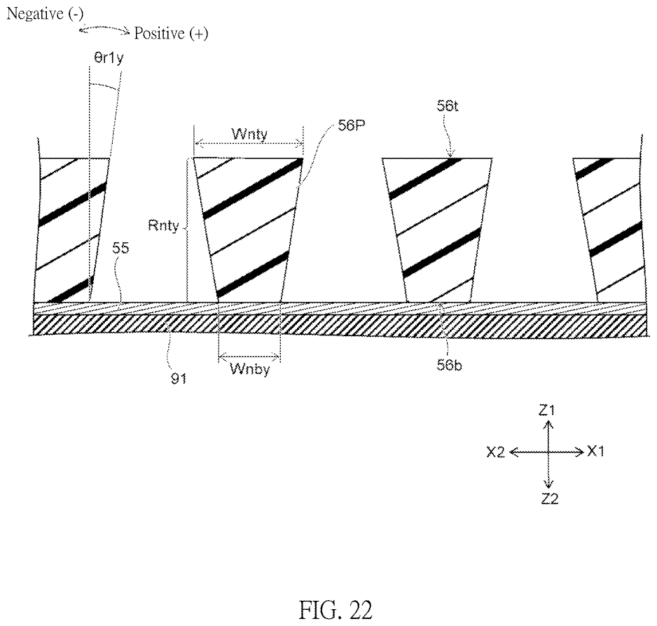

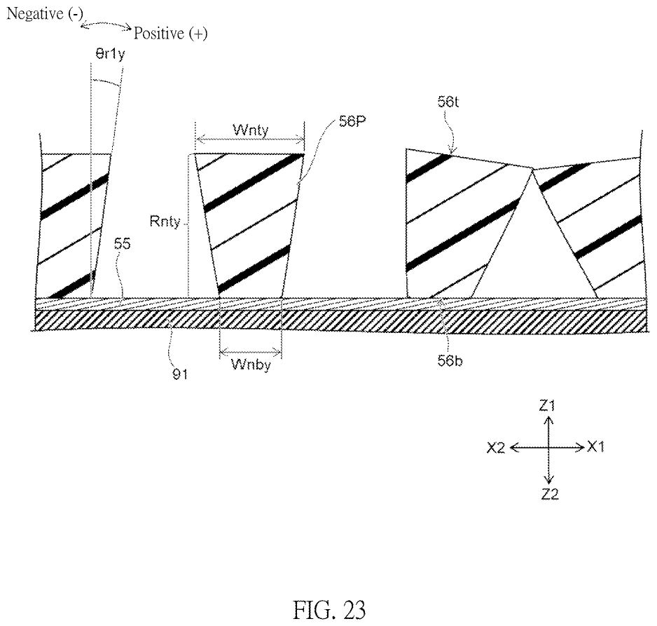

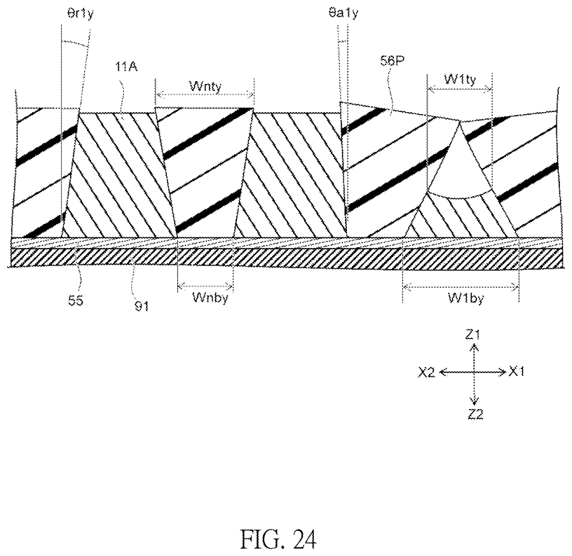

FIG. 21 is a detailed diagram illustrating an example of a method for manufacturing a coil component (exposure process) according to a conventional technique (No. 2), FIG. 22 is a detailed diagram illustrating an example of the method for manufacturing a coil component (after development process) according to the conventional technique (No. 2), FIG. 23 is a detailed diagram illustrating an example of the method for manufacturing a coil component (after development process, when a defect occurs) according to the conventional technique (No. 2), and FIG. 24 is a detailed diagram illustrating an example of the method for manufacturing a coil component (after first plating process when a defect occurs) according to the conventional technique (No. 2).

In the manufacturing method according to the conventional technique (No. 2), in comparison with the method for manufacturing the coil component 100 according to this embodiment, the position of the depth of focus Rf in the exposure process is different. Specifically, as shown in FIG. 21, exposure is performed so that the entire region of the insulating layer 56 (negative resist 56r) in the Z1-Z2 direction is located in the front region Rff. Two-dot chain lines in FIG. 21 indicate the optical path of the exposure process in this embodiment. Since the exposure is performed in this manner, a width Weby on a side proximal to the sheet substrate 91 in an exposure region becomes narrower than a width Wety on a distal side.

The negative pattern 56P obtained by development based on this exposure becomes a negative taper region Rnty whose width in the X1-X2 direction narrows toward the Z2 side in the Z1-Z2 direction over the entire region in the Z1-Z2 direction, as shown in FIG. 22. Therefore, a width Wnby of a bottom surface 56b of the negative pattern 56P becomes narrower than a width Wnty of a top surface 56t.

The width Wnty is narrower than the width Wnb on the side proximal to the sheet substrate 91 of the negative pattern 56P formed by the manufacturing method according to this embodiment shown in FIG. 16. For this reason, the negative pattern 56P according to the conventional technique (No. 2) is more unstable than the negative pattern 56P according to this embodiment, and there are cases where an appropriate shape cannot be maintained as shown in FIG. 22. Specifically, as shown in FIG. 23, the negative pattern 56P may be inclined during development, or adjacent top surfaces 56t may not be appropriately separated in the X1-X2 direction.

For this reason, when the first plating process is performed to deposit the first conductive material on the conductive layer 55 exposed laterally (X1-X2 direction) to the negative pattern 56P, the shape of the first conductor portion 11A may deviate such that an average inclination angle θa1y of the first conductor portion 11A deviates from an average inclination angle θr1y of the negative pattern 56P, as shown in FIG. 24. In this case, when the first plating process is performed, as shown in FIG. 24, variations in the average inclination angle of the negative pattern 56P are transferred, and a first conductor portion 11A with varied average inclination angles is formed. Therefore, the cross section of a turn formed including a subsequent second plating process deviates from an ideal quadrangular shape. Furthermore, as shown on the X1 side in the X1-X2 direction in FIG. 23, when top surfaces 56t of adjacent negative patterns 56P are not appropriately separated, deposition of the first conductive material in the first plating process is not appropriately performed, and as shown in FIG. 24, the shape of the first conductor portion 11A significantly deviates from a shape based on the negative pattern 56P. In this case as well, the cross section of a turn formed including a subsequent second plating process deviates from an ideal quadrangular shape.

As described above, since the negative pattern 56P formed by the method for manufacturing the coil component 100 according to this embodiment is superior in shape stability compared to the negative pattern 56P according to the conventional technique (No. 2), the shape stability of the first conductor portion 11A having an inverted shape of this negative pattern 56P is also superior in the first conductor portion 11A according to this embodiment. This advantage becomes more pronounced as the coil component 100 becomes smaller and the gap between adjacent turns of the coil conductor portion 20 becomes smaller.

Furthermore, the fact that the cross-sectional shape of the first conductor portion 11A according to this embodiment has a straight region on a side portion contributes to an improvement in shape stability of the second conductor portion 11B formed on the first conductor portion 11A, as explained below. Since the cross-sectional shape of the first conductor portion 11A formed from the negative pattern 56P according to the conventional technique (No. 2) is a trapezoid having a wide bottom surface on the sheet substrate 91 side, when the cross-sectional shape of the first conductor portion 11A according to this embodiment and the cross-sectional shape of the first conductor portion 11A according to the conventional technique (No. 2) are compared assuming the bottom portions on the sheet substrate 91 side have a common length, the cross-sectional shape of the first conductor portion 11A according to the conventional technique (No. 2) has a shorter length of a top portion separated from the sheet substrate 91.

For this reason, comparing a gap between two first conductor portions 11A adjacent on the sheet substrate 91, the first conductor portion 11A according to the conventional technique (No. 2) having a cross-sectional shape with a relatively short top portion length becomes remarkably wider near the top portion than the first conductor portion 11A according to this embodiment. Therefore, in the second plating process performed on the first conductor portion 11A according to the conventional technique (No. 2), a difference between the circulation efficiency of the plating solution near the top portion and the circulation efficiency near the bottom portion tends to be large. Since the difference in the deposition rate of the second conductive material constituting the second conductor portion 11B becomes larger as the difference in the circulation efficiency of the plating solution is larger, in the second conductor portion 11B formed on the first conductor portion 11A according to the conventional technique (No. 2), the deposition thickness at the top portion tends to be particularly larger than the deposition thickness at the bottom portion. Since large deposition thickness leads to large variation and lowers controllability of deposition thickness, the second conductor portion 11B according to the conventional technique (No. 2) has low shape controllability at the top portion, and therefore, in the conventional technique (No. 2), it is difficult to obtain a turn having an ideal quadrangular cross-sectional shape.

In contrast, since the first conductor portion 11A according to this embodiment has a straight region on the side portion of the cross-sectional shape as described above, a difference in plating circulation efficiency between the vicinity of the top portion and the vicinity of the bottom portion is relatively small. Therefore, the second conductor portion 11B formed on the first conductor portion 11A according to this embodiment has high shape stability, and as a result, the coil conductor portion 20 of the coil component 100 according to this embodiment tends to have a turn with an ideal quadrangular cross-sectional shape.

### (Electronic/Electric Device)

The electronic/electric device according to an embodiment of the present invention is an electronic/electric device on which the coil component 100 according to the embodiment of the present invention is mounted, and the coil component 100 is connected to a substrate via the first external electrode 41 and the second external electrode 42. Since the electronic/electric device according to an embodiment of the present invention has the coil component 100 according to an embodiment of the present invention mounted thereon, it is easy to miniaturize the device. In addition, even if a large current flows or a high frequency is applied within the device, defects caused by functional degradation or heat generation of the coil component 100 are less likely to occur.

The embodiments and examples described above are provided to facilitate understanding of the present invention, and are not described to limit the present invention. Therefore, each element disclosed in the above embodiments is intended to include all design changes and equivalents within the technical scope of the present invention.

For example, in the present embodiment, the coil conductor portion 20 is provided with the second conductor portion 11B so as to cover the first conductor portion 11A, and most of the outer surface of the second conductor portion 11B constitutes an outer surface of the turn, but the present invention is not limited to this. Another conductor portion may be further provided so as to cover the second conductor portion 11B. Further, in the present embodiment, in the coil conductor portion 20, the third conductor portion 11C is positioned so as to cover a part of the first conductor portion 11A, but the third conductor portion 11C may not be provided.

The structure in which the second conductor portion 11B extends around the Z2 side in the Z1-Z2 direction as shown in FIG. 6B and FIG. 7B can be obtained in the manufacturing method by, after performing the process of removing the negative pattern 56P and the exposed conductive layer 55 following the first plating process, instead of performing a second plating process and then performing partial removal of the sheet substrate 91, first performing a process of substantially removing the sheet substrate 91 and then performing a second plating process. As a result, the second conductor portions 11B, 21B, 14B, 24B are formed so as to cover the third conductor portions 11C, 21C, 14C, 24C composed of the conductive layer 55 in contact with the first conductor portions 11A, 21A, 14A, 24A.

Furthermore, when the second plating process is performed after substantially removing the sheet substrate 91 as in the above manufacturing method, if a step of removing the third conductor portions 11C, 21C, 14C, 24C is performed after the sheet substrate 91 is removed, and then the second plating process is performed, the coil conductor portion 20 will have a structure that does not include the third conductor portions 11C, 21C, 14C, 24C.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A coil component, comprising:
a coil conductor portion including a portion formed with a spiral shape, where a first direction serves as a winding axis direction, and including more than one turn aligned in a second direction intersecting the first direction,
wherein the coil conductor portion further comprises:
a first conductor portion made of a first conductive material and having a portion extending along an extending direction of the more than one turn; and
a second conductor portion made of a second conductive material and provided so as to cover at least a part of the first conductor portion,
wherein when the turn is cut along a plane including the first direction and the second direction to obtain a first cross section,
among lines forming an outer shape of the first conductor portion in the first cross section, two lines aligned in the second direction have a taper region whose spacing becomes narrower toward a tip on one side in the first direction, and a straight region whose spacing is substantially equal on the other side in the first direction, and
among lines forming an outer shape of the turn in the first cross section, two lines aligned in the second direction have a spacing that becomes wider toward the tip on the one side in the first direction, or the spacing is substantially equal.

2. The coil component according to claim 1, wherein:
for two surfaces of the first conductor portion facing the first direction, when one having a longer length in the second direction is defined as a first bottom surface and the other is defined as a first top surface,
a width W1b that is a length of the first bottom surface in the second direction,
a width W1t that is a length of the first top surface in the second direction,
a width W2b that is a length of the turn in the second direction at a position of the first bottom surface, and
a width W2t that is a length in the second direction of a surface proximal to the first top surface among two surfaces facing the first direction in the turn,
satisfy the following formula (1) and the following formula (2):
$$W 1 b > W 1 t \qquad ( 1 )$$
$$( W 1 t / W 1 b ) / ( W 2 t / W 2 b ) < 0.93 . \qquad ( 2 )$$

3. The coil component according to claim 1, wherein the first conductive material includes a crystalline metallic material, and a crystal growth direction of the crystalline metallic material is along the first direction.

4. The coil component according to claim 1, wherein the coil conductor portion includes:
a first spiral conductor portion and a second spiral conductor portion aligned in the first direction as the portion having the spiral shape, and
a via portion electrically connecting an inner end part of the first spiral conductor portion and an inner end part of the second spiral conductor portion.

5. The coil component according to claim 4, further comprising:
a main body portion covering at least a part of the coil conductor portion from both sides in the first direction and containing a magnetic powder; and
a pair of external electrodes in contact with a surface of the coil conductor portion exposed from the main body portion and electrically connected through the coil conductor portion,
wherein a surface of at least a part of a portion located inside the main body portion in the coil conductor portion is covered with a coil insulator portion.

6. An electronic/electric device on which the coil component according to claim 5 is mounted, wherein the coil component is connected to a substrate via the pair of external electrodes.

7. A method for manufacturing a coil component to manufacture a coil conductor portion having a spiral shape with a first direction as a winding axis direction, the method comprising:
forming an insulating negative pattern on a conductive layer of a substrate having the conductive layer on a main surface whose normal is the first direction;
forming a first conductor portion by an electroplating process in which an electric current is applied to the conductive layer;
removing the negative pattern;
removing the conductive layer exposed by removal of the negative pattern; and
forming a second conductor portion so as to cover an exposed portion of the first conductor portion,
wherein:
the negative pattern has a stripe portion in which a plurality of lines are aligned in a second direction that is one of in-plane directions of the main surface, and
formation of the stripe portion includes performing exposure such that a portion distal from the substrate in a sheet-shaped negative resist provided on the main surface is positioned in front of a depth of focus.

8. The method for manufacturing a coil component according to claim 7, wherein a length of the depth of focus is 35% or more of a thickness of the first conductor portion.

9. The method for manufacturing a coil component according to claim 7, wherein a development surface formed by development in one of the lines of the stripe portion has a negative taper region inclined with respect to the first direction, and a negative straight region along the first direction.

10. A coil component, comprising:
a coil conductor portion including a portion formed with a spiral shape, where a first direction serves as a winding axis direction, and including more than one turn aligned in a second direction intersecting the first direction,
wherein the coil conductor portion further comprises:
a first conductor portion made of a first conductive material and having a portion extending along an extending direction of the turn; and
a second conductor portion made of a second conductive material and provided so as to cover at least a part of the first conductor portion,
wherein:
when the turn is cut along a plane including the first direction and the second direction to obtain a first cross section,
among lines forming an outer shape of the first conductor portion in the first cross section, two lines aligned in the second direction are divided into two equal parts in the first direction to define a first region R1 and a second region R2 from one end side,
among lines forming an outer shape of the turn in the first cross section, two lines aligned in the second direction are divided into two equal parts in the first direction to define a third region R3 and a fourth region R4 from the one end side, and
for an average inclination angle of each region with respect to the first direction, when an inclination in a direction in which the two lines approach each other is defined as positive,
the average inclination angle θ1 of the first region is larger than both the average inclination angle θ2 of the second region and the average inclination angle θ3 of the third region.

11. The coil component according to claim 10, wherein:
for two surfaces of the first conductor portion facing the first direction, when one having a longer length in the second direction is defined as a first bottom surface and the other is defined as a first top surface,
a width W1b that is a length of the first bottom surface in the second direction,
a width W1t that is a length of the first top surface in the second direction,
a width W2b that is a length of the turn in the second direction at a position of the first bottom surface, and
a width W2t that is a length in the second direction of a surface proximal to the first top surface among two surfaces facing the first direction in the turn,
satisfy the following formula (1) and the following formula (2):
$$W 1 b > W 1 t \qquad ( 1 )$$
$$( W 1 t / W 1 b ) / ( W 2 t / W 2 b ) < 0.93 . \qquad ( 2 )$$

12. The coil component according to claim 10, wherein the first conductive material includes a crystalline metallic material, and a crystal growth direction of the crystalline metallic material is along the first direction.

13. The coil component according to claim 10, wherein the coil conductor portion includes:
a first spiral conductor portion and a second spiral conductor portion aligned in the first direction as the portion having the spiral shape, and
a via portion electrically connecting an inner end part of the first spiral conductor portion and an inner end part of the second spiral conductor portion.

14. The coil component according to claim 13, further comprising:
a main body portion covering at least a part of the coil conductor portion from both sides in the first direction and containing a magnetic powder; and
a pair of external electrodes in contact with a surface of the coil conductor portion exposed from the main body portion and electrically connected through the coil conductor portion,
wherein a surface of at least a part of a portion located inside the main body portion in the coil conductor portion is covered with a coil insulator portion.

15. An electronic/electric device on which the coil component according to claim 14 is mounted, wherein the coil component is connected to a substrate via the pair of external electrodes.
